(19) United States
(12) Patent Application Publication
(10) Pub. No.: US 2025/0056337 A1
(43) Pub. Date: Feb. 13, 2025

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Xin YOU, Dongguan (CN); Xue LIN, Dongguan (CN); Jiangsheng FAN, Dongguan (CN)

(21) Appl. No.: 18/929,283

(22) Filed: Oct. 28, 2024

Related U.S. Application Data
(63) Continuation of application No. PCT/CN2022/090519, filed on Apr. 29, 2022.

(51) Int. Cl. H04W 36/00; H04W 36/36

(52) U.S. Cl. CPC H04W 36/0058; H04W 36/362

(57) ABSTRACT

A wireless communication method includes: determining a measurement result of at least one cell; and in a case where a cell whose measurement result meets a corresponding condition exists in the at least one cell, performing, through a layer 1 or a layer 2, any one of: reporting cell quality information of the at least one cell, reporting cell quality information of at least one first candidate cell, and triggering a handover process.

### CROSS-REFERENCE TO RELATED APPLICATION

This application is a Continuation Application of International Application No. PCT/CN2022/090519 filed on Apr. 29, 2022, which is incorporated herein by reference in its entirety.

### TECHNICAL FIELD

Embodiments of the present application relate to the field of communications, and more specifically, to a wireless communication method, a terminal device, and a network device.

### RELATED ART

Similar to the long term evolution (LTE) system, the new radio (NR) system supports a handover process of terminal devices in a connected state. In a case where a terminal device that is using network services moves from one cell to another cell, or due to wireless transmission service load adjustment, activation operation maintenance, device failure, etc., and in order to ensure the communication continuity and the service quality, the system must transfer the communication link between the terminal device and a source cell to a target cell, that is, perform a handover process. The process includes the following three phases: handover preparation, handover execution, and handover completion. In the handover preparation phase, a source base station triggers the terminal device to perform a neighboring cell measurement, so that the terminal device may measure the neighboring cell and report the measurement result to the source base station.

Since a concept of beamforming is introduced in the NR system, the terminal device performs measurements on each beam separately in the implementation of a radio resource management (RRM) measurement. In some scenarios, the terminal device performs the RRM measurements through the physical layer to obtain a plurality of beam measurement results and report them to a radio resource control (RRC) layer. The RRC layer may obtain cell measurement results based on these beam measurement results. However, currently, the cell measurement results are reported by a layer 3, the RRC layer. Therefore, a transmission path of the cell measurement results is from the layer 3 to a layer 2 and then to a layer 1, and finally reported to the source base station. The method of reporting the cell measurement results has a large reporting delay due to the long transmission path. In other scenarios, a network device may require the terminal device to report the beam measurement results and decide the cell handover situation based on the beam measurement results. Usually, the beam measurement results are reported periodically through the layer 1 or under the indication of the network device. During the handover preparation phase, the network device is generally not clear about the mobility of the terminal device. Therefore, the current method of reporting the beam measurement results cannot well implement the cell handover. In some other scenarios, the terminal device may trigger the handover process through the layer 3. However, since a message of the layer 3 needs to be transmitted to the layer 2 and then to the layer 1, and finally reported to the target base station, the method has a longer handover delay due to the longer message transmission path.

### SUMMARY

The embodiments of the present application provide a wireless communication method, a terminal device, and a network device.

In a first aspect, a wireless communication method is provided, the method is applied to a terminal device, and the method includes: determining a measurement result of at least one cell; and in a case where a cell whose measurement result meets a corresponding condition exists in the at least one cell, performing any one of the following through a layer 1 or a layer 2: reporting cell quality information of the at least one cell, reporting cell quality information of at least one first candidate cell, and triggering a handover process, where a first candidate cell is a candidate cell whose measurement result meets the corresponding condition in the at least one cell.

In a second aspect, a wireless communication method is provided, the method is applied to a network device, and the method includes: receiving cell quality information of at least one cell or cell quality information of at least one first candidate cell reported by a terminal device through a layer 1 or a layer 2; where the cell quality information of the at least one cell or the cell quality information of the at least one first candidate cell is reported to the network device from the terminal device in a case where a cell whose measurement result meets a corresponding condition exists in the at least one cell; and a first candidate cell is a candidate cell whose measurement result meets the corresponding condition in the at least one cell.

In a third aspect, a terminal device is provided, including: a processing unit and a communication unit. The processing unit is configured to determine a measurement result of at least one cell; and the communication unit is configured to perform any one of the following through a layer 1 or a layer 2 in a case where a cell whose measurement result meets a corresponding condition in the at least one cell: reporting cell quality information of the at least one cell, reporting cell quality information of at least one first candidate cell, where a first candidate cell is a candidate cell whose measurement result meets the corresponding condition in the at least one cell; or, the processing unit is further configured to trigger a handover process.

In a fourth aspect, a network device is provided, including: a communication unit, configured to receive cell quality information of at least one cell or cell quality information of at least one first candidate cell reported by a terminal device through a layer 1 or a layer 2; where the cell quality information of the at least one cell or the cell quality information of the at least one first candidate cell is reported to the network device from the terminal device in a case where a cell whose measurement result meets a corresponding condition in the at least one cell; and a first candidate cell is a candidate cell whose measurement result meets the corresponding condition in the at least one cell.

In a fifth aspect, a terminal device is provided, including a processor and a memory. The memory is configured to store a computer program, and the processor is configured to invoke and execute the computer program stored in the memory to perform the method in the above-mentioned first aspect or any of its various implementations.

In a sixth aspect, a network device is provided, including a processor and a memory. The memory is configured to store a computer program, and the processor is configured to invoke and execute the computer program stored in the memory to perform the method in the above-mentioned second aspect or any of its various implementations.

In a seventh aspect, an apparatus is provided for implementing the method in any one of the first to second aspects above or any of their various implementations.

In some embodiments, the apparatus includes: a processor, configured to invoke a computer program from a memory and run the computer program, so as to enable a device equipped with the apparatus to perform the method in any one of the first to second aspects or any of their various implementations.

In an eighth aspect, a non-transitory computer-readable storage medium is provided for storing a computer program, and the computer program enables a computer to perform the method in any one of the first to second aspects above or any of their various implementations.

In a ninth aspect, a computer program product is provided, including computer program instructions, and the computer program instructions enable a computer to perform the method in any one of the first to second aspects or any of their various implementations.

In a tenth aspect, a computer program is provided, when being executed on a computer, the computer program enables the computer to perform the method in any one of the first to second aspects or any of their various implementations.

### BRIEF DESCRIPTION OF THE DRAWINGS

FIG. 1 is a schematic diagram of a communication system architecture provided in the embodiments of the present application;

FIG. 2 is a schematic block diagram of a cell handover method provided in the embodiments of the present application;

FIG. 3 is a flowchart of a wireless communication method provided in the embodiments of the present application;

FIG. 4 is a schematic block diagram of a cell handover method provided in the embodiments of the present application;

FIG. 5 is a schematic block diagram of a cell handover method provided in the embodiments of the present application;

FIG. 6 is a schematic diagram of a terminal device 600 provided in the embodiments of the present application;

FIG. 7 is a schematic diagram of a network device 700 provided in the embodiments of the present application;

FIG. 8 is a schematic structural diagram of a communication device 800 provided in the embodiments of the present application;

FIG. 9 is a schematic structural diagram of an apparatus according to the embodiments of the present application.

### DETAILED DESCRIPTION

The technical solutions in the embodiments of the present application will be described below in conjunction with the drawings in the embodiments of the present application. Obviously, the described embodiments are only part of the embodiments of the present application, rather than all of the embodiments. With respect to the embodiments of the present application, all other embodiments obtained by ordinary skills in the art without making any creative work shall fall within the scope of protection of the present application.

The embodiments of the present application may be applied to various communication systems, such as a global system of mobile communication (GSM) system, a code division multiple access (CDMA) system, a wideband code division multiple access (WCDMA) system, a general packet radio service (GPRS), a LTE system, an advanced long term evolution (LTE-A) system, an NR system, an NR system evolution system, a LTE-based access to unlicensed spectrum (LTE-U) system, an NR-based access to unlicensed spectrum (NR-U) system, a universal mobile telecommunication System (UMTS), wireless local area networks (WLAN), a wireless fidelity (WiFi), a next generation communication system or other communication systems.

Generally speaking, traditional communication systems support a limited number of connections and are easy to implement. However, with the development of communication technologies, mobile communication systems will not only support traditional communications, but will also support, for example, device to device (D2D) communication, machine to machine (M2M) communication, machine type communication (MTC), and vehicle to vehicle (V2V) communication. The embodiments of the present application may also be applied to these communication systems.

The embodiments of the present application do not limit the applied spectrum. For example, the embodiments of the present application may be applied to a licensed spectrum or to an unlicensed spectrum.

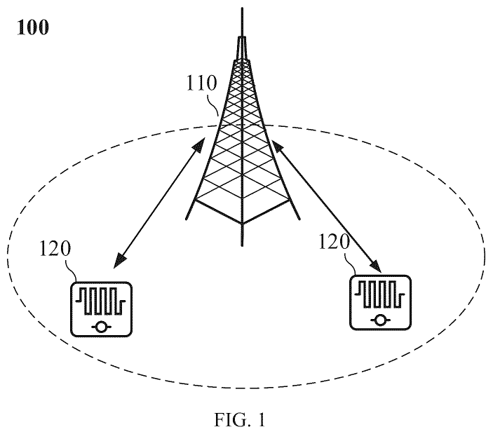

For example, a communication system 100 used in the embodiments of the present application is shown in FIG. 1. The communication system 100 may include a network device 110, the network device may be a device for communicating with a terminal device 120 (or referred to as a communication terminal or terminal). The network device 110 may provide communication coverage for a specific geographical area and may communicate with terminal devices located within the coverage area.

For example, one network device and two terminal devices are shown in FIG. 1. Optionally, the communication system 100 may include a plurality of network devices and in the coverage area of each network device, another number of terminal devices may exist, which is not limited in the embodiments of the present application.

Optionally, the communication system 100 may also include a network controller, a mobility management entity and other network entities, which is not limited in the embodiments of the present application.

It should be understood that a device having a communication function in a network/system in the embodiments of the present application may be referred to as a communication device. The communication system 100 shown in FIG. 1 is taken as an example, the communication devices may include a network device 110 and a terminal device 120 with communication functions. The network device 110 and the terminal device 120 may be the exemplary devices described above and will not be repeated here; the communication devices may further include other devices in the communication system 100, such as a network controller, a mobile management entity, and other network entities, which is not limited in the embodiments of the present application.

It should be understood that the terms “system” and “network” are often used interchangeably herein. The term “and/or” in the present application is merely a description of the association relationship of associated objects, indicating that three relationships may exist. For example, A and/or B may mean three cases: A alone, A and B both, and B alone. In addition, the character “/” in the present application generally indicates that the associated objects before and after the character “/” are in an “or” relationship.

The embodiments of the present application describe various embodiments in conjunction with a terminal device and a network device, herein the terminal device may also be referred to as a user equipment (UE), an access terminal, a user unit, a user station, a mobile station, a mobile station, a remote station, a remote terminal, a mobile device, a user terminal, a terminal, a wireless communication device, a user agent or a user device, etc. The terminal device may be a station (STATION, STA) in the WLAN, a cellular phone, a cordless phone, a session initiation protocol (SIP) phone, a wireless local loop (WLL) station, a personal digital assistant (PDA) device, a handheld device with wireless communication functions, a computing device or other processing device connected to a wireless modem, a vehicle-mounted device, a wearable device, and a terminal device in a next-generation communication system (such as a NR network) or a terminal device in a future evolved public land mobile network (PLMN).

As an example but not limitation, in the embodiments of the present application, the terminal device may also be a wearable device. The wearable device may also be called a wearable smart device. The wearable device is a general term for the intelligent design and development of wearable devices for daily wear using wearable technology, such as glasses, a glove, a watch, clothing or shoes. The wearable device is a portable device that is worn directly on the body or integrated into the user's clothing or accessories. The wearable devices are not just hardware devices, but also implement powerful functions through software support, data interaction, and cloud interaction. In a broad sense, the wearable smart devices include those that are fully functional, large in size, and may achieve complete or partial functions without relying on smartphones, such as smart watches or smart glasses, as well as those that only focus on a certain type of application function and need to be used in conjunction with other devices such as smartphones, such as various smart bracelets and smart jewelry for vital sign monitoring.

The network device may be a device used to communicate with a mobile device. The network device may be an access point (AP) in the WLAN, a base transceiver station (BTS) in the GSM or CDMA, a base station (NodeB, NB) in the WCDMA, and also may be an evolutional base station (evolutional node B, eNB or eNodeB) in the LTE, or a relay station or access point, or a vehicle-mounted device, a wearable device, and a network device or base station (gNB) in the NR network, or a network device in the future evolved PLMN network, etc.

In the embodiments of the present application, the network device provides services for a cell, and the terminal device communicates with the network device through transmission resources (e.g., frequency domain resources, or spectrum resources) used by the cell. The cell may be a cell corresponding to the network device (e.g., a base station). The cell may belong to a macro base station, may also belong to a base station corresponding to a small cell, and the small cell here may include: a metro cell, a micro cell, a pico cell, a femto cell, etc. These small cells have the characteristics of small coverage and low transmission power, and are suitable for providing high-speed data transmission services.

Currently, in a case where the terminal device that is using network services moves from one cell to another cell, or due to wireless transmission service load adjustment, activation operation maintenance, device failure, etc., in order to ensure communication continuity and service quality, the system must transfer the communication link between the terminal device and the source cell to a target cell, that is, perform a handover process.

An Xn interface handover process is taken as an example, the handover process may be divided into the following three phases.
(1) Handover preparation phase. The handover preparation phase includes measurement control and reports, handover request and acknowledgement. A handover request acknowledgement message includes a handover command generated by a target base station. The source cell does not allow any modification to the handover command and directly delivers the handover command to the terminal device.
(2) Handover execution phase. After receiving the handover command, the terminal device immediately executes the handover process, that is, the terminal device detaches from the source cell and connects to the target cell (such as performing random access, and transmitting an RRC handover completion message to the target base station); further, the sequence number (SN) state transfer and data delivering are performed.
(3) Handover completion phase. The target cell performs path switch with the authentication management function (AMF) and user plane function (UPF), and releases the terminal device context of the source base station.

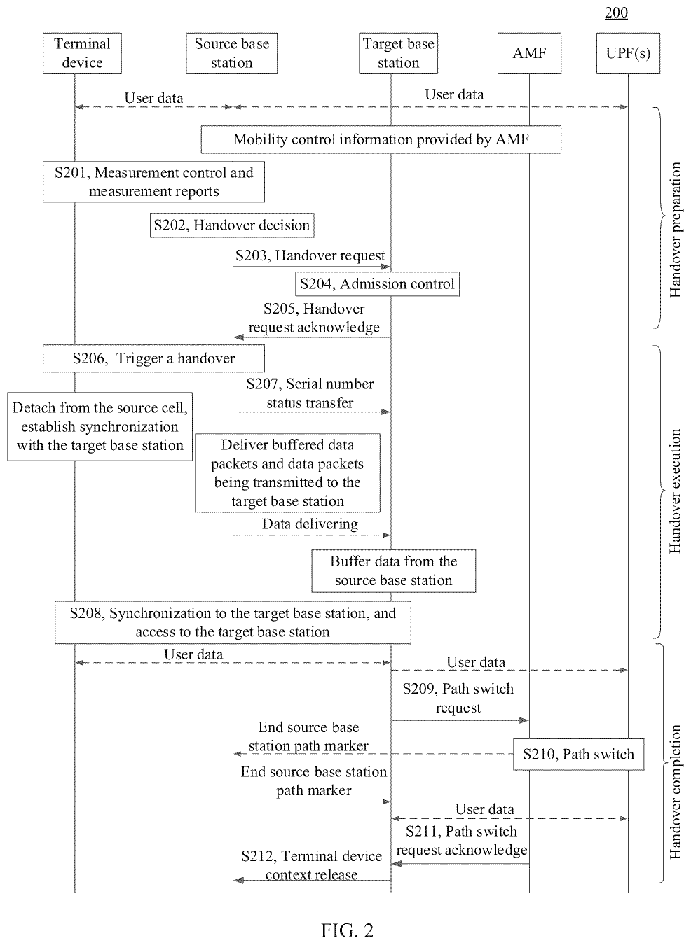

FIG. 2 is a schematic block diagram of a cell handover method provided in the embodiments of the present application.

As shown in FIG. 2, the handover preparation phase (S201 to S205) may include the following.

In S201, the source base station triggers the terminal device to perform a neighboring cell measurement, so that the terminal device may measure the neighboring cell and report the measurement result to the source base station.

In S202, the source base station evaluates the measurement result reported by the terminal device and decides whether to trigger the handover.

In S203, if the source base station decides to trigger a handover, a handover request may be transmitted to the target base station.

In S204, after receiving the handover request transmitted from the source base station, the target base station may start admission according to service information carried by the source base station, and perform wireless resource configuration.

In S205, the target base station transmits a handover request acknowledgement message to the source base station, returning an admission result and wireless resource configuration information in the target base station to the source base station. Thus, the handover preparation phase is completed.

As shown in FIG. 2, the handover execution phase (S206 to S208) may include the following.

In S206, after receiving the handover request acknowledgement message from the target base station, the source base station may trigger the terminal device to switch.

In S207, the source base station may deliver buffered data, data packets being transmitted, system sequence number of the data, etc. to the target base station. Furthermore, the target base station may buffer the data received from the source base station.

In addition, the terminal device may detach from the source base station and establish synchronization with the target base station.

In S208, the terminal device is synchronized to the target base station. Thus, the handover execution phase is completed.

As shown in FIG. 2, the handover completion phase (S209 to S212) may include the following.

In S209, the target base station transmits a path switch request to the AMF.

In S210, after receiving the path switch request from the target base station, the AMF performs path switch with the UPF and ends path marker of the user plane of the source base station.

In S211, after the path switch is completed, the AMF may transmit a path switch acknowledgement message to the target base station.

In S212, the target base station transmits a terminal device context release message to the source base station, notifying the source base station that the handover is successful, and triggering the source base station to release the terminal device context. Thus, the handover is complete.

As mentioned above, since the concept of beamforming is introduced in the NR system, in the implementation of RRM measurement, the terminal device measures each beam separately. In some scenarios, the terminal device performs the RRM measurement through the physical layer to obtain a plurality of beam measurement results and report them to the RRC layer. The RRC layer may obtain cell measurement results based on the beam measurement results. However, currently, the cell measurement results are reported by a layer 3, the RRC layer. Therefore, the transmission path of the cell measurement results is from the layer 3 to a layer 2 and then to a layer 1, and finally reported to the source base station. The method of reporting cell measurement results has a large reporting delay due to the long transmission path. In order to solve the technical problem, in the present application, the terminal device may report the cell measurement results through the layer 1 or the layer 2. Since the transmission path of the cell measurement results is shortened, the reporting delay may be reduced.

As mentioned above, in other scenarios, the network device may require the terminal device to report the beam measurement results and decide on the cell handover based on the beam measurement results. Usually, the beam measurement results are reported by the layer 1periodically or under the indication of the network device. In the handover preparation phase, the network device is generally not clear about the mobility of the terminal device. Therefore, the current method of reporting beam measurement results cannot well implement the cell handover. In order to solve the technical problem, in the present application, the terminal device may independently determine whether to report the beam measurement results, so that the cell handover may be well implemented.

As mentioned above, in some scenarios, the terminal device may trigger the handover process through the layer 3. However, since a layer 3 message needs to be transmitted to the layer 2 and then to the layer 1, and finally reported to the target base station, the method has a long handover delay due to the long message transmission path. In order to solve the technical problem, in the present application, the terminal device may trigger the handover process through the layer 1 or the layer 2. Since the message transmission path is shortened, the handover delay may be reduced.

It should be understood that the layer 3 is used to deliver control messages. For example, the layer 3 may include the internet protocol (IP) layer and the radio resource control (RRC) layer, as well as the non-access stratum (NAS). The layer 2 is used to provide correct transmission and reception of signaling messages, including partial duplicate detection. For example, a packet data convergence protocol (PDCP) layer, a radio link control protocol (RLC) layer, and a media access control (MAC) layer may be included in the layer 2. The layer 1 is used to provide transmission between the base station and the terminal device and receive a wireless link. For example, the layer 1 may include a physical layer.

In the embodiments, a wireless communication method is provided, which is applied to a terminal device and includes:
determining a measurement result of at least one cell;
in a case where a cell whose measurement result meets a corresponding condition exists in the at least one cell, performing, through a layer 1 or a layer 2, any one of: reporting cell quality information of the at least one cell, reporting cell quality information of at least one first candidate cell, or triggering a handover process, where a first candidate cell is a candidate cell whose measurement result meets the corresponding condition in the at least one cell.

In some embodiments, the at least one cell includes: at least one candidate cell, or at least one candidate cell and a source cell.

In some embodiments, a measurement result of the candidate cell meeting the corresponding condition includes at least one of:
a cell measurement result of the candidate cell being greater than a first threshold;
a beam measurement result of at least one beam of the candidate cell being greater than a second threshold; or
a number of beams in the candidate cell with beam measurement results greater than the second threshold being greater than a third threshold.

In some embodiments, at least one of the first threshold, the second threshold or the third threshold is a pre-configured threshold.

In some embodiments, a measurement result of the source cell meeting the corresponding condition includes at least one of:
a cell measurement result of the source cell being less than or equal to a fourth threshold;
a beam measurement result of at least one beam of the source cell being less than or equal to a fifth threshold; or
a number of beams in the source cell with beam measurement results less than the fifth threshold being greater than a sixth threshold.

In some embodiments, at least one of the fourth threshold, the fifth threshold or the sixth threshold is a pre-configured threshold.

In some embodiments, a measurement result of the candidate cell meeting the corresponding condition includes at least one of:
a difference between a cell measurement result of the candidate cell and a cell measurement result of the source cell being greater than a seventh threshold;
a difference between a beam measurement result of at least one beam of the candidate cell and a beam measurement result of at least one beam in the source cell being greater than an eighth threshold; or
a number of beams in the candidate cell with a difference between beam measurement results corresponding to the candidate cell and the source cell greater than the eighth threshold being greater than a ninth threshold.

In some embodiments, at least one of the seventh threshold, the eighth threshold or the ninth threshold is a pre-configured threshold.

In some embodiments, the at least one beam of the candidate cell is all beams or part of the beams of the candidate cell.

In some embodiments, the part of beams of the candidate cell are a beam with a best beam measurement result in the candidate cell or a beam in a beam list configured by a network device for the candidate cell.

In some embodiments, the at least one beam of the source cell is all beams or part of beams of the source cell.

In some embodiments, the part of beams of the source cell are a beam with a best beam measurement result in the source cell or a beam in a beam list configured by a network device for the source cell.

In some embodiments, for any one cell of the at least one cell or the at least one first candidate cell, the cell quality information includes at least one of:
a cell measurement result of the cell;
an index corresponding to the cell measurement result of the cell;
a beam measurement result of at least one beam of the cell;
an index corresponding to the beam measurement result; or indication information used to indicate whether a measurement result of the cell meets the corresponding condition.

In some embodiments, the cell quality information further includes: an identifier of the cell.

In some embodiments, the identifier of the cell is an absolute identifier or a relative identifier.

In some embodiments, indication information corresponding to the at least one cell or the at least one first candidate cell constitutes a first bitmap.

In some embodiments, the cell quality information further includes: an identifier of the at least one beam of the cell.

In some embodiments, the identifier of the at least one beam of the cell is an absolute identifier or a relative identifier.

In some embodiments, the method further includes:
reporting a second bitmap corresponding to the at least one cell in a case where the cell whose measurement result meets the corresponding condition exists in the at least one cell;
where each bit in the second bitmap corresponds to each cell of the at least one cell respectively, and each bit in the second bitmap indicates whether cell quality information of a corresponding cell is reported.

In some embodiments, the at least one first candidate cell is a target cell.

In some embodiments, for any one cell of the at least one cell, determining the cell measurement result of the cell includes:
determining at least one beam measurement result of the cell;
determining a cell measurement result of the cell according to the at least one beam measurement result of the cell.

In some embodiments, determining the cell measurement result of the cell according to the at least one beam measurement result of the cell includes:
calculating an average value of the at least one beam measurement result of the cell to obtain the cell measurement result of the cell.

In some embodiments, determining the cell measurement result of the cell according to the at least one beam measurement result of the cell includes:
calculating an average value of beam measurement results greater than a tenth threshold in the at least one beam measurement result to obtain the cell measurement result of the cell.

In some embodiments, determining the cell measurement result of the cell according to the at least one beam measurement result of the cell includes:
calculating an average value of first N beam measurement results greater than a tenth threshold in the at least one beam measurement result to obtain the cell measurement result of the cell, where the N is a positive integer.

In some embodiments, determining the cell measurement result of the cell according to the at least one beam measurement result of the cell includes:
determining an average value of a best beam measurement result in the at least one beam measurement result and a beam measurement result whose difference from the best beam measurement result is within an eleventh threshold as the cell measurement result of the cell.

In some embodiments, the at least one beam measurement result is any one of: a beam measurement result of at least one beam measured at a same time, beam measurement results of one beam measured at different times, or a beam measurement result of at least one beam measured in a preset time period.

In some embodiments, determining the cell measurement result of the cell according to the at least one beam measurement result of the cell includes:
determining a best beam measurement result in the at least one beam measurement result as the cell measurement result of the cell.

In some embodiments, determining the measurement result of the at least one cell includes: determining the cell measurement result of the at least one cell through the layer 1 or the layer 2.

In some embodiments, before determining the cell measurement result of the at least one cell through the layer 1, the method further includes:
determining a beam measurement result of the at least one cell through the layer 1;
where the determining the measurement result of the at least one cell through the layer 1 includes:
determining the cell measurement result of the at least one cell according to the beam measurement result of the at least one cell through the layer 1.

In some embodiments, before determining the cell measurement result of the at least one cell through the layer 2, the method further includes:
determining a beam measurement result of the at least one cell through the layer 1; and
transmitting the beam measurement result of the at least one cell to the layer 2 through the layer 1; and
where the determining the measurement result of the at least one cell through the layer 2 includes:
determining the cell measurement result of the at least one cell according to the beam measurement result of the at least one cell through the layer 2.

In some embodiments, in a case of reporting the cell quality information of the at least one cell or reporting the cell quality information of the at least one first candidate cell through the layer 1, the cell measurement result of the at least one cell or the cell measurement result of the at least one first candidate cell is determined through the layer 2 or a layer 3, and is transmitted to the layer 1.

In some embodiments, in a case of reporting the cell quality information of the at least one cell or reporting the cell quality information of the at least one first candidate cell through the layer 2, the cell measurement result of the at least one cell or the cell measurement result of the at least one first candidate cell is determined through the layer 1 or a layer 3, and is transmitted to the layer 2.

In some embodiments, the method further includes:
receiving a measurement configuration transmitted from a network device; and measuring the at least one cell based on the measurement configuration.

In some embodiments, the measurement configuration includes at least one of: a threshold corresponding to a cell measurement result, a threshold corresponding to a beam measurement result, a candidate cell list, or a beam list.

In some embodiments, in a case where the cell whose measurement result meets the corresponding condition exists in the at least one cell, performing, through the layer 1 or the layer 2, any one of: reporting the cell quality information of the at least one cell, reporting the cell quality information of at least one first candidate cell, or triggering the handover process, includes:
in a case where the cell whose measurement result meets the corresponding condition exists in the at least one cell, and a duration of the case where the cell whose measurement result meets the corresponding condition exists in the at least one cell reaches a preset duration, performing, through the layer 1 or the layer 2, any one of: reporting the cell quality information of the at least one cell, reporting the cell quality information of the at least one first candidate cell, or triggering the handover process.

In some embodiments, after reporting the cell quality information of the at least one cell or the cell quality information of the at least one first candidate cell, the method further includes:
receiving a handover command transmitted from a network device; and
switching to a target cell based on the handover command.

In some embodiments, the handover command is a layer 1 signaling or a layer 2 signaling.

In some embodiments, the handover command is downlink control information (DCI) or media access control control element (MAC CE).

In some embodiments, the handover command includes at least one of the following: an identifier of the target cell, a timing advance (TA), a cell radio network temporary identity (C-RNTI), a transmission configuration indication (TCI) status of a common channel, a TCI status of a dedicated channel, activation/deactivation information of a secondary cell, or a TCI status of the secondary cell.

In some embodiments, the target cell is distinguished from the source cell by any one of: a cell identifier, a transmission reception point (TRP), a reference information set, a resource, a control resource set, a control resource set pool, a hybrid automatic repeat request (HARQ) process, or a protocol stack TCI status list.

In some embodiments, in a case where the cell whose measurement result meets the corresponding condition exists in the at least one cell, triggering the handover process includes:
determining whether there is a candidate cell in the at least one cell that meets a target condition in a case where the cell whose measurement result meets the corresponding condition existing in the at least one cell; and
triggering the handover process in a case where there is the candidate cell that meets the target condition.

In some embodiments, for any one candidate cell in the at least one cell, determining whether the candidate cell meets the target condition includes:
receiving first indication information transmitted from the layer 1 through the layer 2, where the first indication information is used to indicate that at least M beam measurement results of the candidate cell are greater than a corresponding threshold, and the M is a positive integer; and
determining whether the candidate cell meets the target condition according to the first indication information through the layer 2.

In some embodiments, determining whether the candidate cell meets the target condition according to the first indication information through the layer 2 includes:
in a case where a number of pieces of the first indication information received by the layer 2 within a preset time range reaches a preset number, determining that the candidate cell meets the target condition.

In some embodiments, determining whether the candidate cell meets the target condition according to the first indication information through the layer 2 includes:
in a case where a number of pieces of the first indication information received by the layer 2 within a preset time range reaches a preset number, and the received first indication information is continuous indication information, determining that the candidate cell meets the target condition.

In some embodiments, for any one candidate cell in the at least one cell, determining whether the candidate cell meets the target condition includes:
receiving second indication information transmitted from the layer 1 through the layer 2, where the second indication information is used to indicate that a cell measurement result of the candidate cell is greater than a corresponding threshold; and determining whether the candidate cell meets the target condition according to the second indication information through the layer 2.

In some embodiments, determining whether the candidate cell meets the target condition according to the second indication information through the layer 2 includes:
in a case where a number of pieces of the second indication information received by the layer 2 within a preset time range reaches a preset number, determining that the candidate cell meets the target condition.

In some embodiments, determining whether the candidate cell meets the target condition according to the second indication information through the layer 2 includes:
in a case where a number of pieces of the second indication information received by the layer 2 within a preset time range reaches a preset number, and the received second indication information is continuous indication information, determining that the candidate cell meets the target condition.

In the embodiments, a wireless communication method is provided, which is applied to a network device and includes:
receiving cell quality information of at least one cell or cell quality information of at least one first candidate cell reported by a terminal device through layer 1 or layer 2;
where the cell quality information of the at least one cell or the cell quality information of the at least one first candidate cell is reported to the network device from the terminal device in a case where a cell whose measurement result meets a corresponding condition exists in the at least one cell; and a first candidate cell is a candidate cell whose measurement result meets the corresponding condition in the at least one cell.

In some embodiments, the at least one cell includes: at least one candidate cell, or at least one candidate cell and a source cell.

In some embodiments, a measurement result of the candidate cell meeting the corresponding condition includes at least one of:
a cell measurement result of the candidate cell being greater than a first threshold;
a beam measurement result of at least one beam of the candidate cell being greater than a second threshold; or
a number of beams in the candidate cell with beam measurement results greater than the second threshold being greater than a third threshold.

In some embodiments, at least one of the first threshold, the second threshold or the third threshold is a pre-configured threshold.

In some embodiments, a measurement result of the source cell meeting the corresponding condition includes at least one of:
a cell measurement result of the source cell being less than or equal to a fourth threshold;
a beam measurement result of at least one beam of the source cell being less than or equal to a fifth threshold; or
a number of beams in the source cell with beam measurement results less than the fifth threshold is greater than a sixth threshold.

In some embodiments, at least one of the fourth threshold, the fifth threshold or the sixth threshold is a pre-configured threshold.

In some embodiments, a measurement result of the candidate cell meeting the corresponding condition includes at least one of:
a difference between a cell measurement result of the candidate cell and a cell measurement result of the source cell being greater than a seventh threshold;
a difference between a beam measurement result of at least one beam of the candidate cell and a beam measurement result of at least one beam in the source cell being greater than an eighth threshold; or
a number of beams in the candidate cell with a difference between beam measurement results corresponding to the candidate cell and the source cell greater than the eighth threshold being greater than a ninth threshold.

In some embodiments, at least one of the seventh threshold, the eighth threshold or the ninth threshold is a pre-configured threshold.

In some embodiments, the at least one beam of the candidate cell is all beams or part of the beams of the candidate cell.

In some embodiments, the part of beams of the candidate cell are a beam with a best beam measurement result in the candidate cell or a beam in a beam list configured by the network device for the candidate cell.

In some embodiments, the at least one beam of the source cell is all beams or part of the beams of the source cell.

In some embodiments, the part of beams of the source cell are a beam with a best beam measurement result in the source cell or a beam in a beam list configured by the network device for the source cell.

In some embodiments, for any one cell of the at least one cell or the at least one first candidate cell, the cell quality information includes at least one of:
a cell measurement result of the cell;
an index corresponding to the cell measurement result of the cell;
a beam measurement result of at least one beam of the cell;
an index corresponding to the beam measurement result; or
indication information used to indicate whether a measurement result of the cell meets the corresponding condition.

In some embodiments, the cell quality information further includes: an identifier of the cell.

In some embodiments, the identifier of the cell is an absolute identifier or a relative identifier.

In some embodiments, indication information corresponding to the at least one cell or the at least one first candidate cell constitutes a first bitmap.

In some embodiments, the cell quality information further includes: an identifier of the at least one beam of the cell.

In some embodiments, the identifier of the at least one beam of the cell is an absolute identifier or a relative identifier.

In some embodiments, the method further includes:
receiving a second bitmap corresponding to the at least one cell reported by the terminal device;
where the second bitmap corresponding to the at least one cell is reported to the network device by the terminal device in a case where a cell whose measurement result meets the corresponding condition exists in the at least one cell; each bit in the second bitmap corresponds to each cell of the at least one cell respectively, and each bit in the second bitmap indicates whether cell quality information of a corresponding cell is reported.

In some embodiments, the at least one first candidate cell is a target cell.

In some embodiments, the method further includes:
transmitting a measurement configuration to the terminal device, so as to enable the terminal device to measure the at least one cell based on the measurement configuration.

In some embodiments, the measurement configuration includes at least one of: a threshold corresponding to a cell measurement result, a threshold corresponding to a beam measurement result, a candidate cell list, or a beam list.

The technical solutions of the present application will be described in detail below.

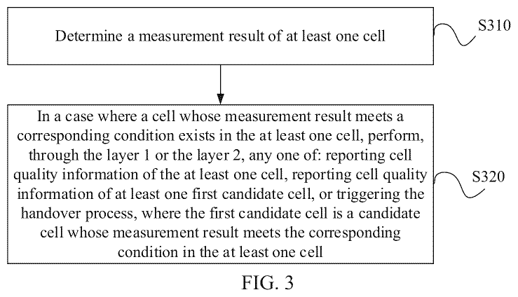

FIG. 3 is a flowchart of a wireless communication method provided in the embodiments of the present application. The method is applied to the terminal device. As shown in FIG. 3, the method may include:
S310, determining a measurement result of at least one cell; and
S320, in a case where a cell whose measurement result meets a corresponding condition exists in the at least one cell, performing, through the layer 1 or the layer 2, any one of: reporting cell quality information of the at least one cell, reporting cell quality information of at least one first candidate cell, or triggering the handover process, where a first candidate cell is a candidate cell whose measurement result meets the corresponding condition in the at least one cell.

It should be understood that the technical solutions of the present application may be applied to a cell handover scenario, for example, applied to the handover preparation phase of the cell handover scenario, and may also be applied to other scenarios, for example, a scenario that requires the terminal device to autonomously report the cell quality information.

Optionally, the at least one cell includes: at least one candidate cell, or at least one candidate cell and a source cell.

Optionally, the at least one candidate cell is configured by the network device for the terminal device, but is not limited thereto.

Optionally, if in the cell handover scenario, the network device in the embodiments of the present application may be the source base station.

Optionally, the terminal device may receive the measurement configuration transmitted from the network device. Further, the terminal device may measure the at least one cell based on the measurement configuration.

Optionally, the terminal device may continuously measure the at least one cell based on the measurement configuration.

Optionally, the measurement configuration includes at least one of the following, but is not limited to: a threshold corresponding to the cell measurement result, a threshold corresponding to the beam measurement result, a candidate cell list, or a beam list.

Optionally, the cell measurement result may be any one of the following, but is not limited to: reference signal received power (RSRP), reference signal received quality (RSRQ), or signal to interference plus noise ratio (SINR).

Optionally, the beam measurement result may be any one of the following, but is not limited to: RSRP, RSRQ, or SINR.

It should be noted that the beam involved in the present application may also be called a spatial domain filter or may correspond to a spatial domain filter, where the transmitting beam may be referred to as a spatial domain transmission filter or may correspond to a spatial domain transmission filter, and the receiving beam may be referred to as a spatial domain receive filter or may correspond to a spatial domain receive filter.

Optionally, the beam involved in the present application may be indicated by a synchronization signal and PBCH block (SSB), a channel state information reference signal (CSI-RS) or spatial information, spatial association information.

It should be noted that the threshold corresponding to the cell measurement result here may be a first threshold, a fourth threshold, a seventh threshold, etc. mentioned below. The threshold corresponding to the beam measurement result here may be a second threshold, a fifth threshold, an eighth threshold described below, and may also be a third threshold, a sixth threshold, a ninth threshold, a tenth threshold, an eleventh threshold, etc. described below.

Optionally, the candidate cell list includes: an identifier of the candidate cell, but is not limited thereto.

Optionally, the beam list includes: a beam identifier of the candidate cell, or the beam identifier of the candidate cell and a beam identifier of the source cell.

Optionally, the threshold corresponding to the above-mentioned cell measurement result and/or the threshold corresponding to the beam measurement result may also be predefined, and the present application does not limited thereto.

Optionally, for any one of the at least one cell mentioned above, the measurement result of the cell includes: the cell measurement result and/or the beam measurement result, but is not limited thereto.

Optionally, for any one of the at least one cell, the terminal device may determine at least one beam measurement result of the cell; and the cell measurement result of the cell is determined based on the at least one beam measurement result of the cell.

Optionally, the at least one beam measurement result of the cell is any one of the following, but not limited to: a beam measurement result of at least one beam at the same time, a beam measurement result of one beam at different times, or a beam measurement result of the at least one beam in a preset time period.

For example, assuming that a candidate cell of the terminal device is configured with 8 beams, then the at least one beam measurement result here may be the beam measurement result of these 8 beams at the current time T1. For another example, assuming that a candidate cell of the terminal device is configured with 8 beams, including beam 1, beam 2, . . . , and beam 8, then the at least one beam measurement result here may be the beam measurement result of the beam 1 at the current time T1 and the beam measurement result at the historical time TO. For yet another example: assuming that a candidate cell of the terminal device is configured with 8 beams, including the beam 1, the beam 2, . . . , and the beam 8, and each beam is measured twice in a preset time period [T0,T1], and the two measurement times are T0 and T1 respectively, then the at least one beam measurement result here may be the beam measurement result of the beam 1 at the current time T1, the beam measurement result of the beam 1 at the historical time T0, the beam measurement result of the beam 2 at the current time T1, and the beam measurement result of the beam 2 at the historical time T0.

Optionally, the at least one beam of the beam measurement result of the at least one beam at the same time and the beam measurement result of the at least one beam in the preset time period may be all the beams of the cell, may also be a beam with the best beam measurement result in the cell, or a beam in the beam list configured by the network device for the cell. This application does not limit thereto.

The terminal device may determine the cell measurement result in the following achievable methods, but is not limited thereto.

In an achievable method 1, the terminal device calculates an average value of the at least one beam measurement result of the cell to obtain the cell measurement result of the cell.

For example, assuming that a candidate cell of the terminal device is configured with 8 beams, then the at least one beam measurement result here may be the beam measurement result of these 8 beams at the current time T1. Furthermore, the terminal device may average the beam measurement result of these 8 beams to obtain the cell measurement result of the cell.

In an achievable method 2, the terminal device calculates the average value of beam measurement results greater than the tenth threshold in the at least one beam measurement result to obtain the cell measurement result of the cell.

For example, assuming that a candidate cell of the terminal device is configured with 8 beams, then the at least one beam measurement result here may be beam measurement results of these 8 beams at the current time T1. Further, assuming that in the beam measurement results of these 8 beams at the current time T1, the beam measurement results that are greater than the tenth threshold are the beam measurement results corresponding to a beam 1, a beam 2 and a beam 3. Further, the terminal device may average beam measurement results of these 3 beams to obtain the cell measurement result of the cell.

In an achievable method 3, the terminal device calculates an average value of first N beam measurement results greater than the tenth threshold in the at least one beam measurement result to obtain the cell measurement result of the cell, where the N is a positive integer.

For example, assuming that a candidate cell of the terminal device is configured with 8 beams, then the at least one beam measurement result here may be the beam measurement results of these 8 beams at the current time T1. Further, assuming that in the beam measurement results of these 8 beams at the current time T1, the beam measurement results that are greater than the tenth threshold are the beam measurement results corresponding to the beam 1, the beam 2 and the beam 3, and the beam measurement results of the beam 1 and the beam 2 are better than the beam measurement result of the beam 3. If N=2, the terminal device may average the beam measurement results of the beam 1 and the beam 2 to obtain the cell measurement result of the cell.

In an achievable method 4, the terminal device determines an average value of a best beam measurement result in the at least one beam measurement result and a beam measurement result whose difference from the best beam measurement result is within an eleventh threshold as the cell measurement result of the cell.

For example, assuming that a candidate cell of the terminal device is configured with 8 beams, then the at least one beam measurement result here may be the beam measurement results of these 8 beams at the current time T1. Further, assuming that the best beam measurement result in the beam measurement results of these 8 beams at the current time T1 is the beam measurement result corresponding to the beam 1, and the beam measurement results corresponding to the beams 2 and the beam 3 are within the eleventh threshold from beam 1, then the terminal device may average the beam measurement results of the beams 1, beam 2 and beam 3 to obtain the cell measurement result of the cell.

In an achievable method 5, the terminal device determines an average value of the best beam measurement result in at least one beam measurement result and first N−1 beam measurement results within the eleventh threshold from the best beam measurement result as the cell measurement result of the cell.

For example, assuming that a candidate cell of the terminal device is configured with 8 beams, then the at least one beam measurement result here may be the beam measurement results of these 8 beams at the current time T1. Further, assuming that the best beam measurement result in the beam measurement results of these 8 beams at the current time T1 is the beam measurement result corresponding to the beam 1, and the beam measurement results corresponding to the beams 2 and beam 3 are within the eleventh threshold from the beam 1, where the beam measurement result of the beam 2 is better than the beam measurement result of the beam 3. Assuming N=2, the terminal device may average the beam measurement results of beam 1 and beam 2 to obtain the cell measurement result of the cell.

In an achievable method 6, the terminal device determines the best beam measurement result in the at least one beam measurement result as the cell measurement result of the cell.

For example, assuming that a candidate cell of the terminal device is configured with 8 beams, then the at least one beam measurement result here may be the beam measurement results of these 8 beams at the current time T1. Further, assuming that the best beam measurement result in the beam measurement results of these 8 beams at the current time T1 is the beam measurement result corresponding to the beam 1, then the terminal device may use the beam measurement result of the beam 1 as the cell measurement result of the cell.

It should be noted that the above-mentioned various achievable methods may be performed under different conditions. For example, the terminal device may average all or the first N beam measurement results that meet the condition to obtain the cell quality. If there is no beam that meets the condition, the terminal considers the best beam measurement result as the cell measurement result, or considers the average of all beam measurement results as the cell measurement result. The condition here may be that the beam measurement result is greater than a certain threshold, but is not limited thereto.

Optionally, in a case of calculating the average value of a plurality of beam measurement results, the terminal device may use a linear averaging method for these beam measurement results, but is not limited thereto.

Optionally, the terminal device may determine the cell measurement result of the at least one cell through the layer 1, the layer 2 or the layer 3.

Optionally, the terminal device may determine the beam measurement result of the at least one cell through the layer 1; and the layer 1 determines the cell measurement result of the at least one cell based on the beam measurement result of the at least one cell.

For example, the terminal device may determine the beam measurement result of the at least one cell through the physical layer; and the physical layer determines the cell measurement result of the at least one cell based on the beam measurement result of the at least one cell.

Optionally, the terminal device may determine the beam measurement result of the at least one cell through the layer 1; the layer 1 transmits the beam measurement result of the at least one cell to the layer 2, and the layer 2 determines the cell measurement result of the at least one cell based on the beam measurement result of the at least one cell.

For example, the terminal device may determine the beam measurement result of the at least one cell through the physical layer; the physical layer transmits the beam measurement result of the at least one cell to a MAC layer, and the MAC layer determines the cell measurement result of the at least one cell based on the beam measurement result of the at least one cell.

Optionally, the terminal device may determine the beam measurement result of the at least one cell through the layer 1; the layer 1 transmits the beam measurement result of the at least one cell to the layer 3, and the layer 3 determines the cell measurement result of the at least one cell based on the beam measurement result of the at least one cell.

For example, the terminal device may determine the beam measurement result of the at least one cell through the physical layer; the physical layer transmits the beam measurement result of the at least one cell to the RRC layer, and the RRC layer determines the cell measurement result of the at least one cell based on the beam measurement result of the at least one cell.

Optionally, for any one candidate cell of the at least one cell, the measurement result of the candidate cell meeting the corresponding condition includes at least one of the following, but is not limited thereto:
(1) the cell measurement result of the candidate cell being greater than the first threshold;
(2) the beam measurement result of at least one beam of the candidate cell being greater than the second threshold; or
(3) the number of beams in the candidate cell with beam measurement results greater than the second threshold being greater than the third threshold.

Optionally, at least one of the first threshold, the second threshold or the third threshold is a pre-configured threshold, for example, at least one of them may be pre-configured by the network device to the terminal device through the above-mentioned measurement configuration. Of course, at least one of the first threshold, the second threshold or the third threshold may also be predefined, or may be configured to the terminal device by other devices, and this application does not limit thereto.

Optionally, the measurement result of the source cell meeting the corresponding condition includes at least one of the following, but is not limited thereto:
(1) the cell measurement result of the source cell being less than or equal to the fourth threshold;
(2) the beam measurement result of the at least one beam of the source cell is less than or equal to the fifth threshold; or
(3) the number of beams in the source cell with beam measurement results less than the fifth threshold is greater than the sixth threshold.

Optionally, at least one of the fourth threshold, the fifth threshold or the sixth threshold is a pre-configured threshold. For example, at least one of them may be pre-configured by the network device to the terminal device through the above measurement configuration. Of course, at least one of the fourth threshold, the fifth threshold or the sixth threshold may also be predefined, or may be configured to the terminal device by other devices, and this application does not limit thereto.

Optionally, the fourth threshold is the same as or different from the first threshold, the fifth threshold is the same as or different from the second threshold, and the sixth threshold is the same as or different from the third threshold.

It should be noted that, in a case where the at least one cell includes the at least one candidate cell, the condition corresponding to the measurement result of the at least one cell may include: the condition corresponding to the measurement result of the candidate cell. In a case where the at least one cell includes the at least one candidate cell and the source cell, the condition corresponding to the measurement result of the at least one cell may include: a condition corresponding to the measurement result of the candidate cell and/or a condition corresponding to the measurement result of the source cell.

For example, assuming that the terminal device is configured with three candidate cells, and the at least one cell mentioned above refers to these three candidate cells, then as long as there is at least one candidate cell in these three candidate cells whose measurement result meets the condition corresponding to the measurement result of the candidate cell, the terminal device may perform any one of the following through the layer 1 or the layer 2: reporting the cell quality information of the at least one cell, reporting the cell quality information of the at least one first candidate cell, and triggering the handover process.

For example, assuming that the terminal device is configured with three candidate cells, and the at least one cell refers to the three candidate cells and the source cell, then as long as there is at least one candidate cell in the three candidate cells whose measurement result meets the condition corresponding to the measurement result of the candidate cell, the terminal device may perform any one of the following through the layer 1 or the layer 2: reporting the cell quality information of the at least one cell, reporting the cell quality information of the at least one first candidate cell, and triggering the handover process.

For example, assuming that the terminal device is configured with three candidate cells, and the at least one cell refers to the three candidate cells and the source cell, then as long as there is at least one candidate cell in the three candidate cells whose measurement result meets the condition corresponding to the measurement result of the candidate cell and the measurement result of the source cell meets the condition corresponding to the measurement result of the source cell, the terminal device may perform any one of the following through the layer 1 or the layer 2: reporting the cell quality information of the at least one cell, reporting the cell quality information of the at least one first candidate cell, and triggering the handover process.

For example, assuming that the terminal device is configured with three candidate cells, the at least one cell refers to the three candidate cells and the source cell. Then, as long as the measurement result of the source cell meets the condition corresponding to the measurement result of the source cell, the terminal device may perform any one of the following through the layer 1 or the layer 2: reporting the cell quality information of the at least one cell, reporting the cell quality information of the at least one first candidate cell, and triggering the handover process.

It should be noted that the condition corresponding to the measurement result of the candidate cell and the condition corresponding to the measurement result of the source cell are independent of each other. In fact, the condition corresponding to the measurement result of the candidate cell may also be the condition corresponding to the measurement result of the candidate cell relative to the source cell. For example, the measurement result of the candidate cell meeting the corresponding condition includes at least one of the following, but is not limited thereto:
(1) the difference between the cell measurement result of the candidate cell and the cell measurement result of the source cell being greater than the seventh threshold;
(2) the difference between the beam measurement result of the at least one beam of the candidate cell and the beam measurement result of the at least one beam of the source cell being greater than the eighth threshold; or
(3) the number of beams in the candidate cells with a difference between corresponding beam measurement results greater than the eighth threshold being greater than the ninth threshold.

Optionally, at least one of the seventh threshold, the eighth threshold or the ninth threshold is a pre-configured threshold. For example, at least one of them may be pre-configured by the network device to the terminal device through the above measurement configuration. Of course, at least one of the seventh threshold, the eighth threshold or the ninth threshold may also be predefined, or may be configured to the terminal device by other devices, and this application does not limit thereto.

Optionally, the at least one beam of the candidate cell may correspond to each cell beam of the at least one beam of the source cell respectively, then the difference between the beam measurement result of the at least one beam of the candidate cell and the beam measurement result of the at least one beam of the source cell may be construed as: that for any one beam in the candidate cell, the difference between the beam measurement results between the beam and the beam corresponding to the beam in the source cell.

Optionally, the difference between the beam measurement result of the at least one beam of the candidate cell and the beam measurement result of the at least one beam of the source cell may also be construed as: that for any one beam in the candidate cell, the difference between the beam measurement result of the beam and the beam measurement result of the beam with the best beam measurement result in the source cell.

In summary, the difference between the beam measurement result of the at least one beam of the candidate cell and the beam measurement result of the at least one beam of the source cell is not limited thereto in the present application.

It should be noted that, in a case where the at least one cell includes the at least one candidate cell, the condition corresponding to the measurement result of the at least one cell may include: the condition corresponding to the measurement result of the candidate cell. In a case where the at least one cell includes the at least one candidate cell and the source cell, the condition corresponding to the measurement result of the at least one cell may include: the condition corresponding to the measurement result of the candidate cell and/or the condition corresponding to the measurement result of the source cell, and the condition corresponding to the measurement result of the candidate cell here refers to a condition corresponding to the measurement result of the candidate cell relative to the source cell.

For example, assuming that the terminal device is configured with three candidate cells, and the at least one cell mentioned above refers to these three candidate cells, then as long as there is at least one candidate cell in these three candidate cells whose measurement result relative to the source cell meets the condition corresponding to the relative measurement result, the terminal device may perform any one of the following through the layer 1 or the layer 2: reporting the cell quality information of the at least one cell, reporting the cell quality information of the at least one first candidate cell, and triggering the handover process.

For example, assuming that the terminal device is configured with three candidate cells, and the at least one cell refers to the three candidate cells and the source cell, then as long as there is at least one candidate cell in the three candidate cells whose measurement result relative to the source cell meets the condition corresponding to the relative measurement result, the terminal device may perform any one of the following through the layer 1 or the layer 2: reporting the cell quality information of the at least one cell, reporting the cell quality information of the at least one first candidate cell, and triggering the handover process.

For example, assuming that the terminal device is configured with three candidate cells, and the at least one cell refers to the three candidate cells and the source cell, then as long as there is at least one candidate cell in the three candidate cells whose measurement result relative to the source cell meets the condition corresponding to the measurement result of the candidate cell and the measurement result of the source cell meets the condition corresponding to the measurement result of the source cell, the terminal device may perform any one of the following through the layer 1 or the layer 2: reporting the cell quality information of the at least one cell, reporting the cell quality information of the at least one first candidate cell, and triggering the handover process.

For example, assuming that the terminal device is configured with three candidate cells, the at least one cell refers to the three candidate cells and the source cell. Then, as long as the measurement result of the source cell meets the condition corresponding to the measurement result of the source cell, the terminal device may perform any one of the following through the layer 1 or the layer 2: reporting the cell quality information of the at least one cell, reporting the cell quality information of the at least one first candidate cell, and triggering the handover process.

Optionally, the at least one beam of the candidate cell may be all beams or part of the beams of the candidate cell. Herein, the part of the beams may be the beam with the best beam measurement result in the candidate cell or the beam in the beam list configured by the network device for the candidate cell.

Optionally, the at least one beam of the source cell may be all beams or part of the beams of the source cell. Herein, the part of beams of the source cell are the beam with the best beam measurement result in the source cell or the beam in the beam list configured by the network device for the source cell.

Optionally, for any one of the at least one cell or the at least one first candidate cell, the cell quality information may include at least one of the following, but is not limited thereto:
(1) the cell measurement result of the cell;
(2) an index corresponding to the cell measurement result of the cell;
(3) the beam measurement result of the at least one beam of the cell;
(4) an index corresponding to the beam measurement result of the at least one beam of the cell; or
(5) indication information used to indicate whether the measurement result of the cell meets the corresponding condition.

Optionally, the network device may configure at least one cell measurement result range and an index corresponding to each cell measurement result range for the terminal device, or the at least one cell measurement result range and the index corresponding to each cell measurement result range are predefined, etc. Based on this, after obtaining the cell measurement result, the terminal device may search for the cell measurement result range to which the cell measurement result belongs, and transmit the index corresponding to the cell measurement result range to the network device. As for the network device, the network device may store at least one cell measurement result range and the index corresponding to each cell measurement result range, and the network device may determine the corresponding cell measurement result range according to the received index.

Optionally, the network device may configure at least one beam measurement result range and an index corresponding to each beam measurement result range for the terminal device, or the at least one beam measurement result range and the index corresponding to each beam measurement result range are predefined, etc. Based on this, after obtaining the beam measurement result, the terminal device may search for the beam measurement result range to which the beam measurement result belongs, and transmit the index corresponding to the beam measurement result range to the network device. As for the network device, it may store the at least one beam measurement result range and the index corresponding to each beam measurement result range, and it may determine the corresponding beam measurement result range according to the received index.

It should be understood that, for any one of the at least one cell or the at least one first candidate cell, the indication information corresponding to the cell is used to indicate whether the cell measurement result of the cell meets the corresponding condition and/or whether the beam measurement result of the cell meets the corresponding condition.

For example, the indication information may occupy two bits, one bit of which is used to indicate whether the cell measurement result of the cell meets the corresponding condition, and the other bit is used to indicate whether the beam measurement result of the cell meets the corresponding condition.

For example, in a case where the measurement result of the cell is only the cell measurement result, the indication information may occupy one bit. In a case of being 1, the value of the one bit indicates that the cell measurement result of the cell meets the corresponding condition. In a case of being 0, the value of the one bit indicates that the cell measurement result of the cell does not meet the corresponding condition. In a case where the measurement result of the cell is only the beam measurement result, the indication information may occupy one bit. In a case of being 1, the value of the one bit indicates that the beam measurement result of the cell meets the corresponding condition. In a case of being 0, the value of the one bit indicates that the beam measurement result of the cell does not meet the corresponding condition. In a case where the measurement result of the cell includes the cell measurement result and the beam measurement result, the indication information may occupy one bit. In a case of being 1, the value of the one bit indicates that the cell measurement result and beam measurement result of the cell both meet the corresponding condition. In a case of being 0, the value of the one bit indicates that the cell measurement result and/or beam measurement result of the cell do not meet the corresponding condition. In a case where each kind of the indication information occupies one bit, the indication information corresponding to the at least one cell or at least one first candidate cell may constitute a bitmap. In order to distinguish the bitmap from another bitmap below, the bitmap may be referred to as a first bitmap.

Optionally, for any one of the at least one cell or at least one first candidate cell, the cell quality information of the cell further includes an identifier of the cell.

Optionally, the identifier of the cell may be an absolute identifier or a relative identifier.

Optionally, the absolute identifier of the cell may be a physical cell ID (PCI) or a cell global identifier (CGI), but is not limited thereto.

Optionally, for any one candidate cell of the at least one first candidate cell, the relative identifier of the candidate cell may be a relative identifier of the candidate cell in the candidate cell list. For example, the relative identifier of the first candidate cell in the candidate cell list is 1, the relative identifier of the second candidate cell is 2, the relative identifier of the third candidate cell is 3, . . . , and the relative identifier of the N-th candidate cell is N.

Optionally, for any one of the at least one cell or at least one first candidate cell, the cell quality information of the cell further includes: an identifier of the at least one beam of the cell.

Optionally, the identifier of the at least one beam of the cell is an absolute identifier or a relative identifier.

Optionally, the absolute identifier of the beam may be any absolute identifier configured by the network device for the beam, for example, the identifier configured by the network device for abeam 1 is beam 1.

Optionally, the relative identifier of a beam may be a relative identifier of the beam in the beam list. For example, the relative identifier of the first beam in the beam list is 1, the relative identifier of the second beam is 2, the relative identifier of the third beam is 3 . . . , and the relative identifier of the N-th beam is N.

Optionally, in a case where a cell whose measurement result meets the corresponding condition exists in the at least one cell, a second bitmap corresponding to the at least one cell is reported; each bit here in the second bitmap corresponds to each cell of the at least one cell, respectively, and each bit in the second bitmap indicates whether the cell quality information of the corresponding cell is reported.

For example, in a case where any bit in the second bitmap takes a value of 1, it indicates that the cell quality information of the corresponding cell is reported, and in a case where any bit in the second bitmap takes a value of 0, it indicates that the cell quality information of the corresponding cell is not reported.

Optionally, in a case where the terminal device may determine a target cell based on the measurement result of the at least one cell above, that is, the cell to be switched, the terminal device may report the cell quality information of the target cell. If the network device confirms that the cell quality information of the target cell meets the corresponding condition, the network device allows the terminal device to switch to the target cell.

Optionally, if the cell quality information of the target cell includes: the cell measurement result of the target cell, the network device determining whether the cell quality information of the target cell meets the corresponding condition, includes that the network device determines whether the cell measurement result of the target cell is greater than a twelfth threshold.

Optionally, if the cell quality information of the target cell includes: the beam measurement result of the target cell, the network device determining whether the cell quality information of the target cell meets the corresponding condition, includes at least one of the following, but not limited to:
(1) the network device determines whether the beam measurement result of the at least one beam of the target cell being greater than a thirteenth threshold; or
(2) the network device determines whether the number of beams in the target cell with the beam measurement results greater than the thirteenth threshold being greater than a fourteenth threshold.

Optionally, at least one of the twelfth threshold, the thirteenth threshold or the fourteenth threshold may also be predefined, which is not limited in the present application.

Optionally, if the cell quality information of the target cell includes: the index corresponding to the cell measurement result of the target cell, then the network device determining whether the cell quality information of the target cell meets the corresponding condition includes: that the network device determines whether a first measurement result of the cell measurement range corresponding to the index corresponding to the cell measurement result, e.g., a left endpoint or a right endpoint, is greater than a fifteenth threshold.

Optionally, if the cell quality information of the target cell includes: the index corresponding to the beam measurement result, then the network device determining whether the cell quality information of the target cell meets the corresponding condition includes at least one of the following, but not limited to:
(1) the network device determines whether a second measurement result of the beam measurement result range corresponding to the index corresponding to the at least one beam measurement result, e.g., a left endpoint or a right endpoint, being greater than a sixteenth threshold; or
(2) the network device determines whether the number of beams with the second measurement result greater than the sixteenth threshold being greater than a seventeenth threshold.

Optionally, at least one of the fifteenth threshold, the sixteenth threshold or the seventeenth threshold may also be predefined, which is not limited in the present application.

Optionally, if the cell quality information of the target cell includes: the indication information used to indicate whether the measurement result of the target cell meets the corresponding condition, then in a case where the indication information indicates that the measurement result of the target cell meets the corresponding condition, the network device may allow the terminal device to switch to the target cell. In a case where the indication information indicates that the measurement result of the target cell does not meet the corresponding condition, the network device may not allow the terminal device to switch to the target cell.

It should be noted that in a case where the cell quality information of the target cell includes a combination of at least two of: the cell measurement result of the target cell, the beam measurement result, the index corresponding to the cell measurement result, the index corresponding to the beam measurement result, and the indication information used to indicate whether the measurement result of the cell meets the corresponding condition, the network device may combine the above conditions to determine whether the terminal device is allowed to switch to the target cell.

It should be understood that, for any one of the at least one cell or at least one first candidate cell, if the cell quality information of the cell is the beam measurement result, as can be seen from the above, the terminal device may determine the beam measurement result through the layer 1 and report the beam measurement result through the layer 1 or layer 2. That is to say, the terminal device may determine and report the beam measurement result through the same layer, or determine and report the beam measurement result through different layers.

For example, the terminal device may determine and report the beam measurement result through the physical layer. For another example, the terminal device may determine the beam measurement result through the physical layer, the physical layer may transmit the beam measurement result to the MAC layer, and the MAC layer reports the beam measurement result to the network device.

It should be understood that, for any one of the at least one cell or the at least one first candidate cell, if the cell quality information of the cell is the cell measurement result, as can be seen from the above, the terminal device may determine the cell measurement result through the layer 1, layer 2 or layer 3, and report the cell measurement result through the layer 1 or layer 2. That is to say, the terminal device may determine and report the cell measurement result through the same layer, or may determine and report the cell measurement result through different layers.

For example, the terminal device may determine and report the cell measurement result through the physical layer.

For example, the terminal device may determine and report the cell measurement result through the MAC layer.

For example, the terminal device may determine the cell measurement result through the MAC layer, the MAC layer transmits the cell measurement result to the physical layer, and the physical layer reports the cell measurement result to the network device.

For example, the terminal device may determine the cell measurement result through the RRC layer, the RRC layer transmits the cell measurement result to the physical layer, and the physical layer reports the cell measurement result to the network device.

For example, the terminal device may determine the cell measurement result through the physical layer, the physical layer transmits the cell measurement result to the MAC layer, and the MAC layer reports the cell measurement result to the network device.

For example, the terminal device may determine the cell measurement result through the RRC layer, the RRC layer transmits the cell measurement result to the MAC layer, and the MAC layer reports the cell measurement result to the network device.

It should be understood that, for any one of the at least one cell or the at least one first candidate cell, if the cell quality information of the cell is the index corresponding to the beam measurement result, although the beam measurement result is determined by the layer 1, the index corresponding to the beam measurement result may be determined by the layer 1, layer 2 or layer 3, and the index corresponding to the beam measurement result is reported through the layer 1 or layer 2. That is to say, the terminal device may determine and report the index corresponding to the beam measurement result through the same layer, or determine and report the index corresponding to the beam measurement result through different layers.

For example, the terminal device may determine and report the index corresponding to the beam measurement result through the physical layer.

For example, the terminal device may determine and report the index corresponding to the beam measurement result through the MAC layer.

For example, the terminal device may determine the index corresponding to the beam measurement result through the MAC layer, the MAC layer transmits the index corresponding to the beam measurement result to the physical layer, and the physical layer reports the index corresponding to the beam measurement result to the network device.

For example, the terminal device may determine the index corresponding to the beam measurement result through the RRC layer, the RRC layer transmits the index corresponding to the beam measurement result to the physical layer, and the physical layer reports the index corresponding to the beam measurement result to the network device.

For example, the terminal device may determine the index corresponding to the beam measurement result through the physical layer, the physical layer transmits the index corresponding to the beam measurement result to the MAC layer, and the MAC layer reports the index corresponding to the beam measurement result to the network device.

For example, the terminal device may determine the index corresponding to the beam measurement result through the RRC layer, the RRC layer transmits the index corresponding to the beam measurement result to the MAC layer, and the MAC layer reports the index corresponding to the beam measurement result to the network device.

It should be understood that, for any one of the at least one cell or the at least one first candidate cell, if the cell quality information of the cell is the index corresponding to the cell measurement result, the index corresponding to the cell measurement result may be determined by the layer 1, layer 2 or layer 3, and the index corresponding to the cell measurement result may be reported through the layer 1 or layer 2. That is to say, the terminal device may determine and report the index corresponding to the cell measurement result through the same layer, or may determine and report the index corresponding to the cell measurement result through different layers.

For example, the terminal device may determine and report the index corresponding to the cell measurement result through the physical layer.

For example, the terminal device may determine and report the index corresponding to the cell measurement result through the MAC layer.

For example, the terminal device may determine the index corresponding to the cell measurement result through the MAC layer, the MAC layer transmits the index corresponding to the cell measurement result to the physical layer, and the physical layer reports the index corresponding to the cell measurement result to the network device.

For example, the terminal device may determine the index corresponding to the cell measurement result through the RRC layer, the RRC layer transmits the index corresponding to the cell measurement result to the physical layer, and the physical layer reports the index corresponding to the cell measurement result to the network device.

For example, the terminal device may determine the index corresponding to the cell measurement result through the physical layer, the physical layer transmits the index corresponding to the cell measurement result to the MAC layer, and the MAC layer reports the index corresponding to the cell measurement result to the network device.

For example, the terminal device may determine the index corresponding to the cell measurement result through the RRC layer, the RRC layer transmits the index corresponding to the cell measurement result to the MAC layer, and the MAC layer reports the index corresponding to the cell measurement result to the network device.

It should be understood that, for any one of the at least one cell or the at least one first candidate cell, if the cell quality information of the cell is the indication information used to indicate whether the measurement result of the cell meets the corresponding condition, the indication information may be determined through the layer 1, layer 2 or layer 3, and the indication information may be reported through the layer 1 or layer 2. That is to say, the terminal device may determine and report the indication information through the same layer, or may determine and report the indication information through different layers.

For example, the terminal device may determine and report the indication information through the physical layer.

For example, the terminal device may determine and report the indication information through the MAC layer.

For example, the terminal device may determine the indication information through the MAC layer, the MAC layer transmits the indication information to the physical layer, and the physical layer reports the indication information to the network device.

For example, the terminal device may determine the indication information through the RRC layer, the RRC layer transmits the indication information to the physical layer, and the physical layer reports the indication information to the network device.

For example, the terminal device may determine the indication information through the physical layer, the physical layer transmits the indication information to the MAC layer, and the MAC layer reports the indication information to the network device.

For example, the terminal device may determine the indication information through the RRC layer, the RRC layer transmits the indication information to the MAC layer, and the MAC layer reports the indication information to the network device.

It should be understood that, if for any one of the at least one cell or at least one first candidate cell, the cell quality information of the cell may include at least two of the following: the cell measurement result of the cell, the index corresponding to the cell measurement result of the cell, the beam measurement result of the at least one beam of the cell, the index corresponding to the beam measurement result of the at least one beam of the cell, and the indication information used to indicate whether the measurement result of the cell meets the corresponding condition. Then, the specific layer through which the terminal device determines and reports the cell quality information may be a combination of the above-mentioned separate determination and reporting situations, and the present application will not repeat here.

The terminal device performs any one of the following through the layer 1 or layer 2: reporting the cell quality information of the at least one cell, reporting the cell quality information of the at least one first candidate cell, or triggering the handover process, which may be implemented in the following cases, but is not limited thereto.

The implementable method 1 is that as long as the cell whose measurement result meets the corresponding condition exists in the above-mentioned at least one cell, the terminal device may perform any one of the following through the layer 1 or layer 2: reporting the cell quality information of the at least one cell, reporting the cell quality information of the at least one first candidate cell, or triggering the handover process.

For example, as long as a cell whose measurement result meets the corresponding condition exists in the above-mentioned at least one cell, the terminal device may perform any one of the following through the physical layer or MAC layer: reporting the cell quality information of the at least one cell, reporting the cell quality information of the at least one first candidate cell, or triggering the handover process.

The implementable method 2 is that in a case where the cell whose measurement result meets the corresponding condition exists in the at least one cell, and a duration of the case where the cell whose measurement result meets the corresponding condition exists in the at least one cell reaches a preset duration, the terminal device may perform any one of the following through the layer 1 or layer 2: reporting the cell quality information of the at least one cell, reporting the cell quality information of the at least one first candidate cell, or triggering the handover process.

For example, in a case where the cell whose measurement result meets the corresponding condition exists in the at least one cell, and a duration of the case where the cell whose measurement result meets the corresponding condition exists in the at least one cell reaches the preset duration, the terminal device may perform any one of the following through the physical layer or MAC layer: reporting the cell quality information of the at least one cell, reporting the cell quality information of the at least one first candidate cell, or triggering the handover process.

Optionally, the preset duration may be configured by the network device, or predefined for the terminal device, or may be configured by other devices for the terminal device, and the present application does not limit thereto.

It should be noted that, in a case where the terminal device reports the cell quality information, the terminal device may report the cell quality information in the following methods in addition to meeting the above-mentioned implementable method 1 or implementable method 2, but is not limited thereto.

In one implementable method, the terminal device may report the cell quality information of the at least one cell or the cell quality information of the at least one first candidate cell through the layer 1 or layer 2 periodically, semi-statically or under an indication of the network device.

Optionally, if the terminal device reports the cell quality information based on the indication of the network device, the indication may be explicit indication information, for example, the indication information is used to activate the terminal device to report the cell quality information. The indication information may include the cell identifier, number of beams, beam identifier, etc. that need to be reported.

Optionally, this periodic reporting method, semi-static reporting method or reporting method based on the indication of the network device may be configured by the network device, or predefined for the terminal device, and the present application does not limit thereto.

In another implementable method, the terminal device may start a timer upon receiving candidate cell configuration, such as after the above-mentioned measurement configuration, and in a case where the timer times out, the cell quality information of the at least one cell or the cell quality information of the at least one first candidate cell is reported through the layer 1 or layer 2.

In summary, in the present application, in a case where a cell whose measurement result meets the corresponding condition exists in the at least one cell, the terminal device may perform any of the following through the layer 1 or layer 2: reporting the cell quality information of the at least one cell, reporting the cell quality information of the at least one first candidate cell, or triggering the handover process. For example, the cell quality information may be the cell measurement result, and since the cell measurement result is reported through the layer 1 or layer 2, the reporting path of the cell measurement result may be reduced, thereby reducing the reporting delay. For another example, the cell quality information may be the beam measurement result, and since the network device is generally not clear about the mobility of the terminal device during the handover preparation phase, the terminal device may use the autonomous reporting method to report the beam measurement result to effectively implement the cell handover. For yet another example, the terminal device may trigger the handover process through the layer 1 or layer 2. This method may reduce the transmission path of the handover message and thereby reducing the handover delay.

Optionally, after reporting the cell quality information of the at least one cell or the cell quality information of the at least one first candidate cell, the target network device, e.g., the target base station, may transmit the handover command to the terminal device, and the terminal device may switch to the target cell based on the handover command.

Optionally, the handover command is a layer 1 or layer 2 signaling.

For example, the handover command may be a physical layer signaling, such as downlink control information (DCI), or the handover command may be a MAC signaling, such as a MAC control element (MAC CE).

Optionally, the handover command includes at least one of the following, but is not limited to: an identifier of the target cell, a timing advance (TA), a cell radio network temporary identity (C-RNTI), a transmission configuration indication (TCI) status of a common channel, a TCI status of a dedicated channel, activation/deactivation information of a secondary cell, or a TCI status of the secondary cell.

Optionally, the source cell and the target cell may be distinguished by different cell identifiers, may also be distinguished by different transmission reception points (TRP), may also be distinguished by different reference signal sets, may also be distinguished by different resources, such as different control resource sets (CORESETs) or control resource set pools (CORESET pool), may also be distinguished by different hybrid automatic repeat request (HARQ) processes, or may also be distinguished by different protocol stacks, such as service data adaptation protocol (SDAP) layer protocol stack, packet data convergence protocol (PDCP) layer protocol stack, radio link control (RLC) layer protocol stack, MAC or physical layer protocol stack. The present application does not limit thereto.

The handover process based on the cell quality information is exemplified below by using an example.

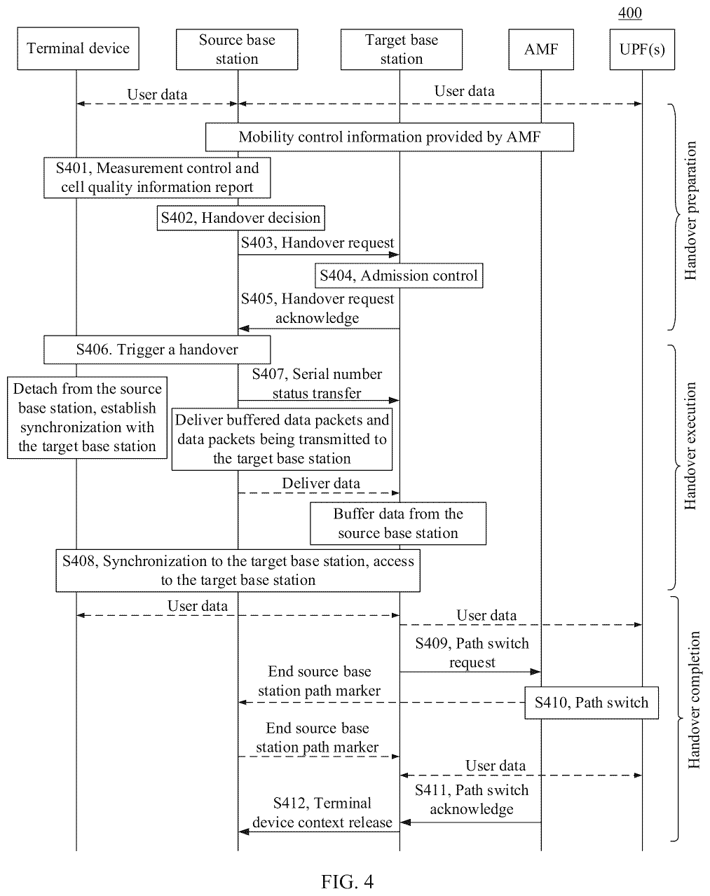

FIG. 4 is a schematic block diagram of a cell handover method provided in the embodiments of the present application.

As shown in FIG. 4, the handover preparation phase (S401 to S405) may include the following.

In S401, the source base station triggers the terminal device to measure the at least one cell, so that the terminal device may measure the at least one cell. In a case where a cell whose measurement result meets the corresponding condition exists in the at least one cell, the terminal device reports the cell quality information to the source base station through the layer 1 or layer 2.

Optionally, the at least one cell includes: the at least one candidate cell, or the at least one candidate cell and the source cell.

Optionally, the cell quality information in the embodiment may be the cell quality information of the at least one cell mentioned above, or may be the cell quality information of at least one first candidate cell, and a first candidate cell is a candidate cell whose measurement result meets the corresponding condition in the at least one cell.

In S402, the source base station evaluates the cell quality information reported by the terminal device and decides whether to trigger the handover.

In S403, if the source base station decides to trigger the handover, the handover request may be transmitted to the target base station.

In S404, after receiving the handover request transmitted from the source base station, the target base station may start admission according to the service information carried by the source base station and perform the wireless resource configuration.

In S405, the target base station transmits the handover request acknowledgement message to the source base station, returning the admission result and wireless resource configuration information in the target base station to the source base station. Thus, the handover preparation phase is completed.

Optionally, the handover request acknowledgement message may include the handover command generated by the target base station. The source cell is not allowed any modification to the handover command and directly delivers the handover command to the terminal device.

As shown in FIG. 4, the handover execution phase (S406 to S408) may include the following.

In S406, after receiving the handover request acknowledgement message from the target base station, the source base station may trigger the terminal device to switch.

In S407, the source base station may deliver the buffered data, the data packets being transmitted, the system sequence number of the data, etc. to the target base station. Furthermore, the target base station may buffer the data received from the source base station.

In addition, the terminal device may detach from the source base station and establish synchronization with the target base station.

In S408, the terminal device is synchronized to the target base station. Thus, the handover execution phase is completed.

As shown in FIG. 4, the handover completion phase (S409 to S412) may include the following.

In S409, the target base station transmits the path switch request to the AMF.

In S410, after receiving the path switch request from the target base station, the AMF performs the path switch with the UPF and ends the path marker of the user plane of the source base station.

In S411, after the path switch is completed, the AMF may transmit a path switch acknowledgement message to the target base station.

In S412, the target base station transmits a terminal device context release message to the source base station, notifying the source base station that the handover is successful, and triggering the source base station to release the terminal device context. Thus, the handover is complete.

In the embodiment, in a case where a cell whose measurement result meets the corresponding condition exists in the at least one cell, the terminal device may report the cell quality information of the at least one cell or the cell quality information of the at least one first candidate cell through the layer 1 or layer 2. For example, the cell quality information may be the cell measurement result, and since the cell measurement result is reported through the layer 1 or layer 2, the reporting path of the cell measurement result may be reduced, thereby reducing the reporting delay. For another example, the cell quality information may be the beam measurement result, and since the network device is generally not clear about the mobility of the terminal device during the handover preparation phase, the terminal device may use the autonomous reporting method to report the beam measurement result to effectively implement the cell handover.

Optionally, in a case where a cell whose measurement result meets the corresponding condition exists in the at least one cell, the terminal device may determine whether a candidate cell that meets the target condition exists in the at least one cell; in a case where the candidate cell that meets the target condition exists, the handover process is triggered.

It should be understood that if the terminal device determines that the candidate cell that meets the target condition exists in the at least one cell, and there is only one candidate cell that meets the target condition, then the terminal device may use the candidate cell as the target cell. If the terminal device determines that the candidate cell that meets the target condition exists in the at least one cell, and there are a plurality of candidate cells that meet the target condition, the terminal device may select one candidate cell as the target cell according to a certain selection strategy.

Optionally, the selection strategy may be a random selection strategy or may be selecting a cell with the best cell measurement result, etc., which is not limited in the present application.

Optionally, for any one candidate cell in the at least one cell, the terminal device receives first indication information through the layer 2 transmitted from the layer 1, and the first indication information is used to indicate that at least M beam measurement results of the candidate cell are greater than the corresponding threshold, where the M is a positive integer; and the layer 2 determines whether the candidate cell meets the target condition based on the first indication information. The M here is configured by the network device for the terminal device, or is predefined, and the present application does not limit thereto.

Optionally, the physical layer may report the first indication information periodically, or may report the first indication information in a case where the terminal device meets a certain condition, for example, in a case where the terminal device determines that at least M beam measurement results of the candidate cell are greater than the corresponding threshold, the first indication information is reported.

In one implementable method, in a case where a number of pieces of the first indication information received by the layer 2 within a preset time range reaches a preset number, it is determined that the candidate cell meets the target condition.

For example, assuming that M=3, the preset time range is 30 s, and the preset number is 2, for any one candidate cell in the at least one cell, if within 30 s the terminal device receives 5 first indication information through the MAC layer, and the first indication information indicates that there are 4 beam measurement results of the candidate cell greater than the corresponding threshold, then the terminal device determines that the candidate cell meets the target condition.

In another implementable method, in a case where a number of pieces of the first indication information received by the layer 2 within a preset time range reaches the preset number, and the received first indication information is continuous indication information, it is determined that the candidate cell meets the target condition.

For example, assuming that M=3, the preset time range is 30 s, and the preset number is 2, for any one candidate cell in the at least one cell, if within 30 s the terminal device receives 5 consecutive first indication information through the MAC layer, and the first indication information indicates that there are 4 beam measurement results of the candidate cell greater than the corresponding threshold, then the terminal device determines that the candidate cell meets the target condition.

Optionally, for any one candidate cell in the at least one cell, the terminal device receives second indication information through the layer 2 transmitted from the layer 1, and the second indication information is used to indicate that the cell measurement result of the candidate cell is greater than the corresponding threshold; and the layer 2 determines whether the candidate cell meets the target condition based on the second indication information.

Optionally, the physical layer may report the second indication information periodically, or may report the second indication information in a case where the terminal device meets a certain condition, for example, in a case where the terminal device determines that the cell measurement result of the candidate cell is greater than the corresponding threshold, the second indication information is reported.

In one implementable method, in a case where a number of pieces of the second indication information received by the layer 2 within a preset time range reaches a preset number, it is determined that the candidate cell meets the target condition.

For example, assuming that M=3, the preset time range is 30 s, and the preset number is 2, for any one candidate cell in the at least one cell, if within 30 s the terminal device receives 5 second indication information through the MAC layer, and the second indication information indicates that the cell measurement result of the candidate cell is greater than the corresponding threshold, then the terminal device determines that the candidate cell meets the target condition.

In another implementable method, in a case where a number of pieces of the second indication information received by the layer 2 within a preset time range reaches the preset number, and the received second indication information is continuous indication information, it is determined that the candidate cell meets the target condition.

For example, assuming that the preset time range is 30 s, and the preset number is 2, for any one candidate cell in the at least one cell, if within 30 s the terminal device receives 5 consecutive second indication information through the MAC layer, and the second indication information indicates that the cell measurement result of the candidate cell is greater than the corresponding threshold, then the terminal device determines that the candidate cell meets the target condition.

The handover process based on the cell quality information is exemplified below by using an example.

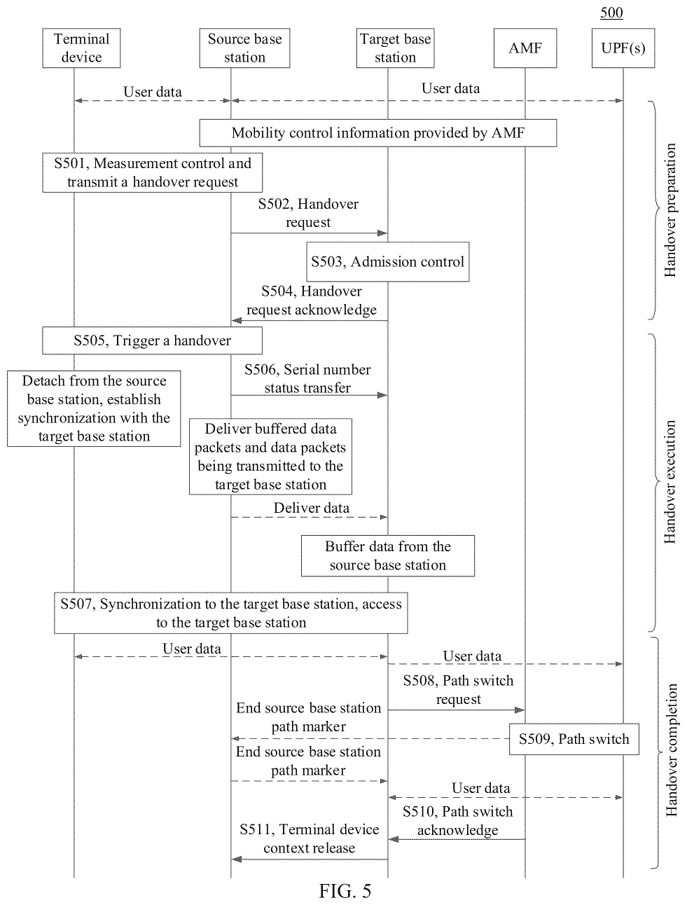

FIG. 5 is a schematic block diagram of a cell handover method provided in the embodiments of the present application.

As shown in FIG. 5, the handover preparation phase (S501 to S504) may include the following.

In S501, the source base station triggers the terminal device to measure the at least one cell, so that the terminal device may measure the at least one cell, and in a case where a cell whose measurement result meets the corresponding condition exists in the at least one cell, the handover request is transmitted to the source base station.

In S502, the source base station may transmit the handover request to the target base station.

In S503, after receiving the handover request transmitted from the source base station, the target base station may start admission according to the service information carried by the source base station and perform wireless resource configuration.

In S504, the target base station transmits the handover request acknowledgement message to the source base station, returning the admission result and wireless resource configuration information in the target base station to the source base station. Thus, the handover preparation phase is completed.

Optionally, the handover request acknowledgement message may include the handover command generated by the target base station, and the source cell is not allowed any modification to the handover command and directly delivers the handover command to the terminal device.

As shown in FIG. 5, the handover execution phase (S505 to S507) may include the following.

In S505, after receiving the handover request acknowledgement message from the target base station, the source base station may trigger the terminal device to switch.

In S506, the source base station may deliver the buffered data, the data packets being transmitted, the system sequence number of the data, etc. to the target base station. Furthermore, the target base station may buffer the data received from the source base station.

In addition, the terminal device may detach from the source base station and establish synchronization with the target base station.

In S507, the terminal device is synchronized to the target base station. Thus, the handover execution phase is completed.

As shown in FIG. 5, the handover completion phase (S508 to S511) may include the following.

In S508, the target base station transmits the path switch request to the AMF.

In S509, after receiving the path switch request from the target base station, the AMF performs the path switch with the UPF and ends the path marker of the user plane of the source base station.

In S510, after the path switch is completed, the AMF may transmit a path switch acknowledgement message to the target base station.

In S511, the target base station transmits a terminal device context release message to the source base station, notifying the source base station that the handover is successful, and triggering the source base station to release the terminal device context. Thus, the handover is completed.

In the embodiment, in the present application, in a case where a cell whose measurement result meets the corresponding condition exists in the at least one cell, the terminal device may trigger the handover process through the layer 1 or layer 2. This method may reduce the transmission path of the handover message, thereby reducing the handover delay.

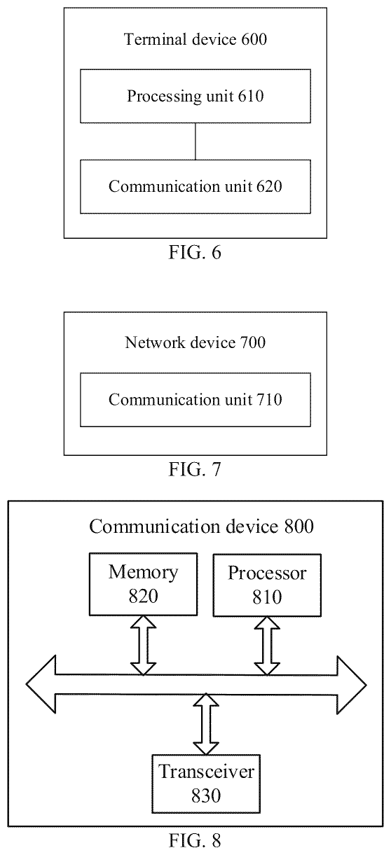

FIG. 6 is a schematic diagram of a terminal device 600 provided in the embodiments of the present application. As shown in FIG. 6, the terminal device 600 includes: a processing unit 610 and a communication unit 620. The processing unit 610 is configured to determine a measurement result of at least one cell; and the communication unit 620 is configured to perform any one of the following through a layer 1 or layer 2 in a case where a cell whose measurement result meets the corresponding condition exists in the at least one cell: reporting cell quality information of the at least one cell, reporting cell quality information of at least one first candidate cell, where a first candidate cell is a candidate cell whose measurement result meets the corresponding condition in the at least one cell; or, the processing unit 610 is further configured to trigger a handover process.

Optionally, the at least one cell includes: the at least one candidate cell, or the at least one candidate cell and a source cell.

Optionally, the measurement result of a candidate cell meeting the corresponding condition includes at least one of the following:
a cell measurement result of the candidate cell being greater than a first threshold;
a beam measurement result of at least one beam of the candidate cell being greater than a second threshold; or
the number of beams in the candidate cell with beam measurement results greater than the second threshold being greater than a third threshold.

Optionally, at least one of the first threshold, the second threshold and or third threshold is a pre-configured threshold.

Optionally, the measurement result of the source cell meeting the corresponding condition includes at least one of the following:
a cell measurement result of the source cell being less than or equal to a fourth threshold;
a beam measurement result of the at least one beam of the source cell being less than or equal to a fifth threshold; or
the number of beams in the source cell with beam measurement results less than the fifth threshold being greater than a sixth threshold.

Optionally, at least one of the fourth threshold, the fifth threshold or the sixth threshold is the pre-configured threshold.

Optionally, the measurement result of the candidate cell meeting the corresponding condition includes at least one of the following:
the difference between the cell measurement result of the candidate cell and the cell measurement result of the source cell being greater than a seventh threshold;
the difference between the beam measurement result of the at least one beam of the candidate cell and the beam measurement result of the at least one beam of the source cell being greater than an eighth threshold; or
a number of beam s in the candidate cell with a difference between beam measurement results corresponding to the candidate cell and the source cell greater than the eighth threshold being greater than a ninth threshold.

Optionally, at least one of the seventh threshold, the eighth threshold or the ninth threshold is the pre-configured threshold.

Optionally, the at least one beam of the candidate cell is all beams or part of beams of the candidate cell.

Optionally, the part of beams of the candidate cell are a beam with a best beam measurement result in the candidate cell or a beam in a beam list configured by the network device for the candidate cell.

Optionally, the at least one beam of the source cell is all beams or part of beams of the source cell.

Optionally, the part of the beams of the source cell are beams with best beam measurement results in the source cell or beams in a beam list configured by the network device for the source cell.

Optionally, for any one of the at least one cell or at least one first candidate cell, the cell quality information includes at least one of the following:
the cell measurement result of the cell;
an index corresponding to the cell measurement result of the cell;
the beam measurement result of the at least one beam of the cell;
an index corresponding to the beam measurement result; or
indication information used to indicate whether the measurement result of the cell meets the corresponding condition.

Optionally, the cell quality information further includes: an identifier of the cell.

Optionally, the identifier of the cell is an absolute identifier or a relative identifier.

Optionally, the indication information corresponding to the at least one cell or at least one first candidate cell constitutes a first bitmap.

Optionally, the cell quality information further includes: an identifier of the at least one beam of the cell.

Optionally, the identifier of the at least one beam of the cell is the absolute identifier or the relative identifier.

Optionally, the communication unit 620 is further configured to report a second bitmap corresponding to the at least one cell in a case where a cell whose measurement result meets the corresponding condition exists in the at least one cell; where each bit in the second bitmap corresponds to each cell of the at least one cell respectively, and each bit in the second bitmap indicates whether the cell quality information of the corresponding cell is reported.

Optionally, the at least one first candidate cell is a target cell.

Optionally, the processing unit 610 is configured to determine the at least one beam measurement result of the cell, for any one cell in the at least one cell; and determine the cell measurement result of the cell according to the at least one beam measurement result of the cell.

Optionally, the processing unit 610 is configured to calculate an average value of the at least one beam measurement result of the cell to obtain the cell measurement result of the cell.

Optionally, the processing unit 610 is configured to calculate an average value of beam measurement results greater than a tenth threshold in the at least one beam measurement result to obtain the cell measurement result of the cell.

Optionally, the processing unit 610 is configured to calculate an average value of first N beam measurement results greater than the tenth threshold in the at least one beam measurement result to obtain the cell measurement result of the cell, where the N is a positive integer.

Optionally, the processing unit 610 is configured to determine an average value of a best beam measurement result in the at least one beam measurement result and a beam measurement result whose difference from the best beam measurement result is within an eleventh threshold as the cell measurement result of the cell.

Optionally, at least one beam measurement result is any one of the following: a beam measurement result of the at least one beam at the same time, a beam measurement result of one beam at different times, or a beam measurement result of at least one beam in a preset time period.

Optionally, the processing unit 610 is configured to determine the best beam measurement result in the at least one beam measurement result as the cell measurement result of the cell.

Optionally, the processing unit 610 is configured to determine the cell measurement result of the at least one cell through the layer 1 or layer 2.

Optionally, the processing unit 610 is further configured to determine the beam measurement result of the at least one cell through the layer 1; and the layer 1 determines the cell measurement result of the at least one cell according to the beam measurement result of the at least one cell.

Optionally, the processing unit 610 is further configured to determine the beam measurement result of the at least one cell through the layer 1, and transmit the beam measurement result of the at least one cell through the layer 1 to the layer 2; and the layer 2 determines the cell measurement result of the at least one cell based on the beam measurement result of the at least one cell.

Optionally, in a case of reporting the cell quality information of the at least one cell or reporting the cell quality information of the at least one first candidate cell through the layer 1, the cell measurement result of the at least one cell or the cell measurement result of the at least one first candidate cell is determined through the layer 2 or a layer 3, and transmitted to the layer 1.

Optionally, in a case of reporting the cell quality information of the at least one cell or reporting the cell quality information of the at least one first candidate cell through the layer 2, the cell measurement result of the at least one cell or the cell measurement result of the at least one first candidate cell is determined through the layer 1 or layer 3, and transmitted to the layer 2.

Optionally, the communication unit 620 is further configured to receive measurement configuration transmitted from a network device; and the processing unit 610 is further configured to measure the at least one cell based on the measurement configuration.

Optionally, the measurement configuration includes at least one of the following: a threshold corresponding to the cell measurement result, a threshold corresponding to the beam measurement result, the candidate cell list, or the beam list.

Optionally, the communication unit 620 is configured to perform any one of the following, in a case where the cell whose measurement result meets the corresponding condition exists in the at least one cell, and a duration of the case where the cell whose measurement result meets the corresponding condition exists in the at least one cell reaches a preset duration: reporting the cell quality information of the at least one cell, or reporting the cell quality information of the at least one first candidate cell through the layer 1 or layer 2. Alternatively, the processing unit 610 is configured to trigger the handover process in a case where the cell whose measurement result meets the corresponding condition exists in the at least one cell, and a duration of the case where the cell whose measurement result meets the corresponding condition exists in the at least one cell reaches the preset duration.

Optionally, the communication unit 620 is further configured to receive a handover command transmitted from the network device; and the processing unit 610 is further configured to switch to the target cell based on the handover command.

Optionally, the handover command is a layer 1 or layer 2 signaling.

Optionally, the handover command is DCI or MAC CE.

Optionally, the handover command includes at least one of the following: an identifier of the target cell, TA, C-RNTI, a TCI status of a common channel, a TCI status of a dedicated channel, activation/deactivation information of a secondary cell, or a TCI status of the secondary cell.

Optionally, the target cell is distinguished from the source cell by any one of the following: a cell identifier, TRP, a reference information set, a resource, a control resource set, a control resource set pool, a HARQ process, or a protocol stack TCI status list.

Optionally, the processing unit 610 is configured to determine whether a candidate cell meeting the target condition exists in the at least one cell in a case where a cell whose measurement result meets the corresponding condition exists in the at least one cell; and trigger the handover process in a case where the candidate cell meets a target condition.

Optionally, the processing unit 610 is configured to: the layer 2 receives the first indication information transmitted from the layer 1, where the first indication information is used to indicate that at least M beam measurement results of the candidate cell are greater than a corresponding threshold, and the M is a positive integer; and the layer 2 determines whether the candidate cell meets the target condition based on the first indication information.

Optionally, the processing unit 610 is configured to determine that the candidate cell meets the target condition in a case where a number of pieces of the first indication information received by the layer 2 within a preset time range reaches a preset number.

Optionally, the processing unit 610 is configured to determine that the candidate cell meets the target condition in a case where a number of pieces of the first indication information received by the layer 2 within a preset time range reaches the preset number, and the received first indication information is continuous indication information.

Optionally, the processing unit 610 is configured to: the layer 2 receives second indication information transmitted from the layer 1, the second indication information is used to indicate that the cell measurement result of the candidate cell is greater than the corresponding threshold; and the layer 2 determines whether the candidate cell meets the target condition according to the second indication information.

Optionally, the processing unit 610 is configured to determine that the candidate cell meets the target condition in a case where a number of pieces of the second indication information received by the layer 2 within a preset time range reaches the preset number.

Optionally, the processing unit 610 is configured to determine that the candidate cell meets the target condition if within the preset time range, the number of the second indication information received by the layer 2 reaches the preset number, and the received second indication information is continuous indication information.

Optionally, the communication unit above may be a communication interface or a transceiver, or an input/output interface of a communication chip or a system on chip. The processing unit above may be one or more processors.

It should be understood that the terminal device 600 according to the embodiments of the present application may correspond to the terminal device in the method embodiments of the present application, and the above-mentioned and other operations and/or functions of each unit in the terminal device 600 are respectively for implementing the corresponding processes of the terminal device in the method embodiments, which will not be repeated here for the sake of brevity.

FIG. 7 is a schematic diagram of a network device 700 provided in the embodiments of the present application. As shown in FIG. 7, the network device 700 includes: a communication unit 710, configured to receive the cell quality information of the at least one cell or the cell quality information of the at least one first candidate cell reported by the terminal device through the layer 1 or layer 2; where the cell quality information of the at least one cell or the cell quality information of the at least one first candidate cell is reported to the network device from the terminal device in a case where a cell whose measurement result meets the corresponding condition exists in the at least one cell; and a first candidate cell is a candidate cell whose measurement result meets the corresponding condition in the at least one cell.

Optionally, the at least one cell includes: the at least one candidate cell, or the at least one candidate cell and the source cell.

Optionally, the measurement result of the candidate cell meeting the corresponding condition includes at least one of the following:
the cell measurement result of the candidate cell being greater than the first threshold;
the beam measurement result of the at least one beam of the candidate cell being greater than the second threshold; or
the number of beams in the candidate cell with beam measurement results greater than the second threshold being greater than the third threshold.

Optionally, at least one of the first threshold, the second threshold or the third threshold is a pre-configured threshold.

Optionally, the measurement result of the source cell meeting the corresponding condition includes at least one of the following:
the cell measurement result of the source cell being less than or equal to the fourth threshold;
the beam measurement result of the at least one beam of the source cell being less than or equal to the fifth threshold; or
the number of beams in the source cell with beam measurement results less than the fifth threshold being greater than the sixth threshold.

Optionally, at least one of the fourth threshold, the fifth threshold or the sixth threshold is the pre-configured threshold.

Optionally, the measurement result of the candidate cell meeting the corresponding condition includes at least one of the following:
the difference between the cell measurement result of the candidate cell and the cell measurement result of the source cell being greater than a seventh threshold;
the difference between the beam measurement result of the at least one beam of the candidate cell and the beam measurement result of the at least one beam of the source cell being greater than an eighth threshold; or
a number of beam s in the candidate cell with a difference between beam measurement results corresponding to the candidate cell and the source cell greater than the eighth threshold being greater than a ninth threshold.

Optionally, at least one of the seventh threshold, the eighth threshold or the ninth threshold is the pre-configured threshold.

Optionally, the at least one beam of the candidate cell is all beams or part of beams of the candidate cell.

Optionally, the part of beams of the candidate cell are a beam with a best beam measurement result in the candidate cell or a beam in a beam list configured by the network device for the candidate cell.

Optionally, the at least one beam of the source cell is all beams or part of beams of the source cell.

Optionally, the part of the beams of the source cell are a beam with a best beam measurement result in the source cell or a beam in a beam list configured by the network device for the source cell.

Optionally, for any one of the at least one cell or at least one first candidate cell, the cell quality information includes at least one of the following:
the cell measurement result of the cell;
the index corresponding to the cell measurement result of the cell;
the beam measurement result of the at least one beam of the cell;
the index corresponding to the beam measurement result; or
the indication information used to indicate whether the measurement result of the cell meets the corresponding condition.

Optionally, the cell quality information further includes: an identifier of the cell.

Optionally, the identifier of the cell is an absolute identifier or a relative identifier.

Optionally, the indication information corresponding to the at least one cell or at least one first candidate cell constitutes a first bitmap.

Optionally, the cell quality information further includes: an identifier of the at least one beam of the cell.

Optionally, the identifier of the at least one beam of the cell is the absolute identifier or the relative identifier.

Optionally, the communication unit 710 is further configured to receive a second bitmap corresponding to the at least one cell reported by the terminal device; where the second bitmap corresponding to the at least one cell is reported to the network device from the terminal device in a case where a cell whose measurement result meets the corresponding condition exists in the at least one cell; and each bit in the second bitmap corresponds to each cell of the at least one cell respectively, and each bit in the second bitmap indicates whether the cell quality information of the corresponding cell is reported.

Optionally, the at least one first candidate cell is the target cell.

Optionally, the communication unit 710 is further configured to transmit the measurement configuration to the terminal device, so as to enable the terminal device to measure the at least one cell based on the measurement configuration.

Optionally, the measurement configuration includes at least one of the following: the threshold corresponding to the cell measurement result, the threshold corresponding to the beam measurement result, the candidate cell list, or the beam list.

Optionally, the communication unit above may be the communication interface or the transceiver, or the input/output interface of the communication chip or the system on chip.

It should be understood that the network device 700 according to the embodiments of the present application may correspond to the network device in the method embodiments of the present application, and the above-mentioned and other operations and/or functions of each unit in the network device 700 are respectively for implementing the corresponding processes of the network device in the method embodiments, which will not be repeated here for the sake of brevity.

FIG. 8 is a schematic structural diagram of a communication device 800 provided in the embodiments of the present application. The communication device 800 shown in FIG. 8 includes a processor 810, and the processor 810 may invoke a computer program from a memory and execute the computer program to implement the method in the embodiments of the present application.

Optionally, as shown in FIG. 8, the communication device 800 may further include a memory 820. The processor 810 may invoke a computer program from the memory 820 and execute the computer program to implement the method in the embodiments of the present application.

The memory 820 may be a separate device independent of the processor 810, or may be integrated into the processor 810.

Optionally, as shown in FIG. 8, the communication device 800 may further include a transceiver 830, and the processor 810 may control the transceiver 830 to communicate with other devices, for example, may transmit information or data to other devices, or receive information or data transmitted from other devices.

The transceiver 830 may include a transmitter and a receiver. The transceiver 830 may further include an antenna, and the number of the antenna may be one or more.

Optionally, the communication device 800 may be the network device of the embodiments of the present application, and the communication device 800 may implement corresponding processes implemented by the network device in various methods of the embodiments of the present application, which will not be repeated here for the sake of brevity.

Optionally, the communication device 800 may be the terminal device of the embodiments of the present application, and the communication device 800 may implement the corresponding processes implemented by the terminal device in various methods of the embodiments of the present application, which will not be repeated here for the sake of brevity.

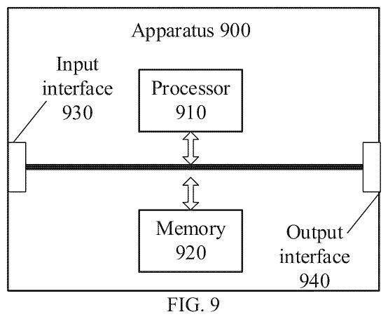

FIG. 9 is a schematic structural diagram of an apparatus according to the embodiments of the present application. The device 900 shown in FIG. 9 includes a processor 910, and the processor may invoke a computer program from a memory and execute the computer program to implement the method in the embodiments of the present application.

Optionally, as shown in FIG. 9, the apparatus 900 may further include a memory 920. The processor 910 may invoke a computer program from the memory 920 and execute the computer program to implement the method in the embodiments of the present application.

The memory 920 may be a separate device independent of the processor 910, or may be integrated into the processor 910.

Optionally, the device 900 may further include an input interface 930. The processor 910 may control the input interface 930 to communicate with other devices or chips, and for example, may obtain information or data transmitted from other devices or chips.

Optionally, the device 900 may further include an output interface 940. The processor 910 may control the output interface 940 to communicate with other devices or chips, and for example, may output information or data to other devices or chips.

Optionally, the apparatus may be applied to the network device in the embodiments of the present application, and the apparatus may implement the corresponding processes implemented by the network device in various methods in the embodiments of the present application, which will not be repeated here for the sake of brevity.

Optionally, the apparatus may be applied to the terminal device in the embodiments of the present application, and the apparatus may implement corresponding processes implemented by the terminal device in various methods in the embodiments of the present application, which will not be repeated here for the sake of brevity.

Optionally, the apparatus mentioned in the embodiments of the present application may also be a chip, e.g., may be a system level chip, a system chip, a chip system, or a system-on-chip chip.

It should be understood that the processor of the embodiments of the present application may be an integrated circuit chip with signal processing capabilities. In the implementation process, various steps of the above method embodiments may be completed by an integrated logic circuit of hardware in the processor or an instruction in software form. The above-mentioned processor may be a general purpose processor, a digital signal processor (DSP), an application specific integrated circuit (ASIC), a field programmable gate array (FPGA) or other programmable logic device, a discrete gate or transistor logic device, or a discrete hardware component. The various methods, steps and logic diagrams disclosed in the embodiments of the present application may be implemented or executed. The general purpose processor may be a microprocessor, or the processor may be any conventional processor or the like. The steps of the method disclosed in the embodiments of the present application may be directly implemented as being executed by a hardware decoding processor, or may be implemented by a combination of hardware and software modules in the decoding processor. The software module may be located in a random access memory, a flash memory, a read-only memory, a programmable read-only memory, or an electrically erasable programmable memory, a register, or other mature storage medium in the art. The storage medium is located in the memory, and the processor reads the information in the memory and completes the steps of the above method in combination with its hardware.

It can be understood that the memory in the embodiments of the present application may be a volatile memory or a non-volatile memory, or may include both volatile and non-volatile memories. Herein, the non-volatile memory may be a read-only memory (ROM), a programmable ROM (PROM), an erasable PROM (EPROM), an electrically EPROM (EEPROM), or a flash memory. The volatile memory may be a random access memory (RAM), which acts as an external cache memory. By way of example and not limitation illustration, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and direct rambus RAM (DR RAM). It should be noted that the memory of the systems and methods described herein is intended to include but is not limited to these and any other suitable types of memories.

It should be understood that the above-mentioned memory is exemplary but not limitation illustration, e.g., the memory in the embodiments of the present application may also be the static RAM (SRAM), the dynamic RAM (DRAM), the synchronous DRAM (SDRAM), the double data rate SDRAM (DDR SDRAM), the enhanced SDRAM (ESDRAM), the synch link DRAM (SLDRAM), or the direct rambus RAM (DR RAM). That is, the memory in the embodiments of the present application is intended to include but is not limited to these and any other suitable types of memories.

The embodiments of the present application further provide a non-transitory computer-readable storage medium for storing a computer program.

Optionally, the non-transitory computer-readable storage medium may be applied to the network device or base station in the embodiments of the present application, and the computer program enables the computer to perform the corresponding processes implemented by the network device or base station in the various methods of the embodiments of the present application. For the sake of brevity, they are not repeated here.

Optionally, the non-transitory computer-readable storage medium may be applied to the mobile terminal/terminal device in the embodiments of the present application, and the computer program enables the computer to perform the corresponding processes implemented by the mobile terminal/terminal device in the various methods of the embodiments of the present application. For the sake of brevity, they are not repeated here.

The embodiments of the present application further provide a computer program product, including computer program instructions.

Optionally, the computer program product may be applied to the network device or base station in the embodiments of the present application, and the computer program instructions enable the computer to perform the corresponding processes implemented by the network device or base station in the various methods of the embodiments of the present application. For the sake of brevity, they are not repeated here.

Optionally, the computer program product may be applied to the mobile terminal/terminal device in the embodiments of the present application, and the computer program instructions enable the computer to perform the corresponding processes implemented by the mobile terminal/terminal device in the various methods of the embodiments of the present application. For the sake of brevity, they are not repeated here.

The embodiments of the present application further provide a computer program.

Optionally, the computer program may be applied to the network device or base station in the embodiments of the present application. When being executed on a computer, the computer program enables the computer to perform the corresponding processes implemented by the network device or base station in the various methods of the embodiments of the present application. For the sake of brevity, they are not repeated here.

Optionally, the computer program may be applied to the mobile terminal/terminal device in the embodiments of the present application. When being executed on a computer, the computer program enables the computer to perform the corresponding processes implemented by the mobile terminal/terminal device in the various methods of the embodiments of the present application. For the sake of brevity, they are not repeated here.

Those skilled in the art will appreciate that the units and algorithm steps of each example described in conjunction with the embodiments disclosed herein may be implemented by electronic hardware, or a combination of computer software and electronic hardware. Whether these functions are performed in hardware or software depends on the application and design constraints of the technical solution. Professional technicians may use different methods to implement the described functions for each specific application, but such implementation should not be considered to be beyond the scope of the present application.

Those skilled in the art can clearly understand that, for the convenience and brevity of description, the working processes of the systems, devices and units described above may refer to the corresponding processes in the aforementioned method embodiments and will not be repeated here.

In several embodiments provided in the present application, it should be understood that the disclosed systems, devices and methods may be implemented in other ways. For example, the apparatus embodiments described above are merely illustrative. For example, the division of the units is merely a logical function division, and there may be other division methods in actual implementation. For example, multiple units or components may be combined or integrated into another system, or some features may be ignored or not executed. Another point is that the mutual coupling or direct coupling or communication connection shown or discussed may be an indirect coupling or communication connection through some interfaces, devices or units, which may be electrical, mechanical or other forms.

The units described as separate components may or may not be physically separated, and the components shown as units may or may not be physical units, that is, they may be located in one place or distributed over multiple network units. Some or all of the units may be selected according to actual needs to achieve the purpose of the solution in the embodiments.

In addition, various functional units in various embodiments of the present application may be integrated into one processing unit, or each unit may exist physically separately, or two or more units may be integrated into one unit.

If the functions are implemented in the form of software functional units and sold or used as an independent product, they may be stored in a non-transitory computer-readable storage medium. Based on such an understanding, the technical solutions of the present application essentially, or the part that contributes to the prior art, or the part of the technical solution may be embodied in the form of a software product. The computer software product is stored in a storage medium and includes a number of instructions for enabling a computer device (which may be a personal computer, a server, or a network device, etc.) to execute all or part of the steps of the method described in various embodiments of the present application. The aforementioned storage medium include: a U disk, a mobile hard disk, a read-only memory (ROM), a random access memory (RAM), a disk or an optical disk and other medium that may store program codes.

The above is only exemplary implementations of the present application, but the protection scope of the present application is not limited thereto, and any skilled familiar with this technical field may easily think of changes or substitutions within the technical scope disclosed in the present application, which should be all covered within the protection scope of the present application. Therefore, the protection scope of the present application should be subject to the protection scope of the claims.

What is claimed is:

1. A wireless communication method, wherein the method is applied to a terminal device, and the method comprises:
determining a measurement result of at least one cell; and
in a case where a cell whose measurement result meets a corresponding condition exists in the at least one cell, performing, through a layer 1 or a layer 2, any one of: reporting cell quality information of the at least one cell, reporting cell quality information of at least one first candidate cell, or triggering a handover process, wherein a first candidate cell is a candidate cell whose measurement result meets the corresponding condition in the at least one cell.

2. The method according to claim 1, wherein the at least one cell comprises: at least one candidate cell, or at least one candidate cell and a source cell;
wherein a measurement result of the candidate cell meeting the corresponding condition comprises at least one of:
a cell measurement result of the candidate cell being greater than a first threshold;
a beam measurement result of at least one beam of the candidate cell being greater than a second threshold; or
a number of beams in the candidate cell with beam measurement results greater than the second threshold being greater than a third threshold;
or
a measurement result of the source cell meeting the corresponding condition comprises at least one of:
a cell measurement result of the source cell being less than or equal to a fourth threshold;
a beam measurement result of at least one beam of the source cell being less than or equal to a fifth threshold; or
a number of beams in the source cell with beam measurement results less than the fifth threshold being greater than a sixth threshold;
or
a measurement result of the candidate cell meeting the corresponding condition comprises at least one of:
a difference between a cell measurement result of the candidate cell and a cell measurement result of the source cell being greater than a seventh threshold;
a difference between a beam measurement result of at least one beam of the candidate cell and a beam measurement result of at least one beam in the source cell being greater than an eighth threshold; or
a number of beams in the candidate cell with a difference between beam measurement results corresponding to the candidate cell and the source cell greater than the eighth threshold being greater than a ninth threshold.

3. The method according to claim 2, wherein the at least one beam of the candidate cell is all beams or part of the beams of the candidate cell; wherein the part of beams of the candidate cell are a beam with a best beam measurement result in the candidate cell or a beam in a beam list configured by a network device for the candidate cell;
or
the at least one beam of the source cell is all beams or part of beams of the source cell; wherein the part of beams of the source cell are a beam with a best beam measurement result in the source cell or a beam in a beam list configured by a network device for the source cell.

4. The method according to claim 1, wherein for any one cell of the at least one cell or the at least one first candidate cell, the cell quality information comprises at least one of:
a cell measurement result of the cell;
an index corresponding to the cell measurement result of the cell;
a beam measurement result of at least one beam of the cell;
an index corresponding to the beam measurement result; or
indication information used to indicate whether a measurement result of the cell meets the corresponding condition;
wherein indication information corresponding to the at least one cell or the at least one first candidate cell constitutes a first bitmap.

5. The method according to claim 1, further comprising:
reporting a second bitmap corresponding to the at least one cell in a case where the cell whose measurement result meets the corresponding condition exists in the at least one cell;
wherein each bit in the second bitmap corresponds to each cell of the at least one cell respectively, and each bit in the second bitmap indicates whether cell quality information of a corresponding cell is reported.

6. The method according to claim 1, wherein in a case of reporting the cell quality information of the at least one cell or reporting the cell quality information of the at least one first candidate cell through the layer 1, the cell measurement result of the at least one cell or the cell measurement result of the at least one first candidate cell is determined through the layer 2 or a layer 3, and is transmitted to the layer 1;
or
in a case of reporting the cell quality information of the at least one cell or reporting the cell quality information of the at least one first candidate cell through the layer 2, the cell measurement result of the at least one cell or the cell measurement result of the at least one first candidate cell is determined through the layer 1 or a layer 3, and is transmitted to the layer 2.

7. The method according to claim 1, further comprising:
receiving a measurement configuration transmitted from a network device; and
measuring the at least one cell based on the measurement configuration;
wherein the measurement configuration comprises at least one of: a threshold corresponding to a cell measurement result, a threshold corresponding to a beam measurement result, a candidate cell list, or a beam list.

8. A terminal device, comprising:
a processor and a memory, wherein the memory is configured to store a computer program, and the processor is configured to invoke and execute the computer program stored in the memory, to cause the terminal device to perform:
determining a measurement result of at least one cell; and
in a case where a cell whose measurement result meets a corresponding condition exists in the at least one cell, performing, through a layer 1 or a layer 2, any one of: reporting cell quality information of the at least one cell, reporting cell quality information of at least one first candidate cell, or triggering a handover process, wherein a first candidate cell is a candidate cell whose measurement result meets the corresponding condition in the at least one cell.

9. The terminal device according to claim 8, wherein the at least one first candidate cell is a target cell.

10. The terminal device according to claim 8, wherein for any one cell of the at least one cell, the terminal device performs:
determining at least one beam measurement result of the cell;
determining a cell measurement result of the cell according to the at least one beam measurement result of the cell.

11. The terminal device according to claim 10, wherein the terminal device performs:
calculating an average value of the at least one beam measurement result of the cell to obtain the cell measurement result of the cell;
or
calculating an average value of beam measurement results greater than a tenth threshold in the at least one beam measurement result to obtain the cell measurement result of the cell;
or
calculating an average value of first N beam measurement results greater than a tenth threshold in the at least one beam measurement result to obtain the cell measurement result of the cell, wherein the N is a positive integer;
or
determining an average value of a best beam measurement result in the at least one beam measurement result and a beam measurement result whose difference from the best beam measurement result is within an eleventh threshold as the cell measurement result of the cell; or
determining a best beam measurement result in the at least one beam measurement result as the cell measurement result of the cell.

12. The terminal device according to claim 8, wherein the terminal device performs:
determining the cell measurement result of the at least one cell through the layer 1 or the layer 2.

13. The terminal device according to claim 8, wherein the terminal device performs:
in a case where the cell whose measurement result meets the corresponding condition exists in the at least one cell, and a duration of the case where the cell whose measurement result meets the corresponding condition exists in the at least one cell reaches a preset duration, performing, through the layer 1 or the layer 2, any one of: reporting the cell quality information of the at least one cell, reporting the cell quality information of the at least one first candidate cell, or triggering the handover process;
and/or
after reporting the cell quality information of the at least one cell or the cell quality information of the at least one first candidate cell, the terminal device further performs:
receiving a handover command transmitted from a network device; and
switching to a target cell based on the handover command.

14. The terminal device according to claim 8, wherein in a case where the cell whose measurement result meets the corresponding condition exists in the at least one cell, the terminal device performs:
determining whether there is a candidate cell in the at least one cell that meets a target condition in a case where the cell whose measurement result meets the corresponding condition existing in the at least one cell; and
triggering the handover process in a case where there is the candidate cell that meets the target condition.

15. A network device, comprising:
a processor and a memory, wherein the memory is configured to store a computer program, and the processor is configured to invoke and execute the computer program stored in the memory, to cause the network device to perform:
receiving cell quality information of at least one cell or cell quality information of at least one first candidate cell reported by a terminal device through layer 1 or layer 2;
wherein the cell quality information of the at least one cell or the cell quality information of the at least one first candidate cell is reported to the network device from the terminal device in a case where a cell whose measurement result meets a corresponding condition exists in the at least one cell; and a first candidate cell is a candidate cell whose measurement result meets the corresponding condition in the at least one cell.

16. The network device according to claim 15, wherein the at least one cell comprises: at least one candidate cell, or at least one candidate cell and a source cell;
wherein a measurement result of the candidate cell meeting the corresponding condition comprises at least one of:
a cell measurement result of the candidate cell being greater than a first threshold;
a beam measurement result of at least one beam of the candidate cell being greater than a second threshold; or
a number of beams in the candidate cell with beam measurement results greater than the second threshold being greater than a third threshold;
or
a measurement result of the source cell meeting the corresponding condition comprises at least one of:
a cell measurement result of the source cell being less than or equal to a fourth threshold;
a beam measurement result of at least one beam of the source cell being less than or equal to a fifth threshold; or
a number of beams in the source cell with beam measurement results less than the fifth threshold is greater than a sixth threshold;
or
a measurement result of the candidate cell meeting the corresponding condition comprises at least one of:
a difference between a cell measurement result of the candidate cell and a cell measurement result of the source cell being greater than a seventh threshold;
a difference between a beam measurement result of at least one beam of the candidate cell and a beam measurement result of at least one beam in the source cell being greater than an eighth threshold; or
a number of beams in the candidate cell with a difference between beam measurement results corresponding to the candidate cell and the source cell greater than the eighth threshold being greater than a ninth threshold.

17. The network device according to claim 16, wherein the at least one beam of the candidate cell is all beams or part of the beams of the candidate cell; the part of beams of the candidate cell are a beam with a best beam measurement result in the candidate cell or a beam in a beam list configured by the network device for the candidate cell;
or
the at least one beam of the source cell is all beams or part of the beams of the source cell;
the part of beams of the source cell are a beam with a best beam measurement result in the source cell or a beam in a beam list configured by the network device for the source cell.

18. The network device according to claim 15, wherein for any one cell of the at least one cell or the at least one first candidate cell, the cell quality information comprises at least one of:
a cell measurement result of the cell;
an index corresponding to the cell measurement result of the cell;
a beam measurement result of at least one beam of the cell;
an index corresponding to the beam measurement result; or
indication information used to indicate whether a measurement result of the cell meets the corresponding condition;
wherein indication information corresponding to the at least one cell or the at least one first candidate cell constitutes a first bitmap.

19. The network device according to claim 15, wherein the network device further performs:
receiving a second bitmap corresponding to the at least one cell reported by the terminal device;
wherein the second bitmap corresponding to the at least one cell is reported to the network device by the terminal device in a case where a cell whose measurement result meets the corresponding condition exists in the at least one cell; each bit in the second bitmap corresponds to each cell of the at least one cell respectively, and each bit in the second bitmap indicates whether cell quality information of a corresponding cell is reported.

20. The network device according to claim 15, wherein the network device further performs:
transmitting a measurement configuration to the terminal device, so as to enable the terminal device to measure the at least one cell based on the measurement configuration;
the measurement configuration comprises at least one of: a threshold corresponding to a cell measurement result, a threshold corresponding to a beam measurement result, a candidate cell list, or a beam list.
